(19) United States
(12) Patent Application Publication
(10) Pub. No.: US 2024/0372149 A1
(43) Pub. Date: Nov. 7, 2024

(54) SULFUR-CARBON COMPOSITE CATHODES IN CARBONATE ELECTROLYTE FOR LITHIUM-SULFUR BATTERIES

(71) Applicant: DREXEL UNIVERSITY, Philadelphia, PA (US)

(72) Inventors: JinWon KIM, Gyeonggi-do (KR); Vibha KALRA, Ithaca, NY (US); Krishna Kumar SARODE, Telangana (IN)

(73) Assignee: DREXEL UNIVERSITY, Philadelphia, PA (US)

(21) Appl. No.: 18/576,492

(22) PCT Filed: Jul. 15, 2022
(86) PCT No.: PCT/US22/73766

§ 371 Date: Jan. 4, 2024

(51) Int. Cl. H01M 10/0569; H01M 4/02; H01M 4/04; H01M 4/583; H01M 4/62; H01M 10/052; H01M 10/0568

(52) U.S. Cl. CPC H01M 10/0569; H01M 4/0471; H01M 4/583; H01M 4/622; H01M 4/625; H01M 10/052; H01M 10/0568; H01M 2004/028; H01M 2300/0042; H01M 2300/0051

(57) ABSTRACT

An electrolyte solvent having a dielectric constant of 10 or less comprising: a) 0% to 30% by volume of one or more of components i)-iii), based on a total volume of the electrolyte solvent: i) one or more unsubstituted cyclic carbonate(s): ii) one or more unsubstituted lactone(s); and iii) one or more unsubstituted oxazolidine(s); and b) 70% to 100% by volume of one or more of components iv)-vii), based on the total volume of the electrolyte solvent: iv) one or more substituted cyclic carbonate(s) having 3-15 carbon atoms: v) one or more substituted lactone(s) having 3-15 carbon atoms; and vi) one or more substituted oxazolidine(s) having 3-15 carbon atoms; and vii) one or more acyclic carbonate(s) having 2-20 carbon atoms. A method of making a cathode and cathodes and batteries made by the methods are also disclosed.

### CROSS-REFERENCE TO RELATED APPLICATIONS

This application claims the benefit of U.S. provisional application No. 63/222,479 filed on Jul. 16, 2021, U.S. provisional application No. 63/363,497, filed on Apr. 25, 2022, and U.S. provisional application No. 63/363,502, filed on Apr. 25, 2022 and is a continuation-in-part of International Application no. PCT/US22/71890, filed on Apr. 25, 2022, which, in turn, claims the benefit of U.S. provisional application No. 63/178,734, filed on Apr. 23, 2021, the entire disclosures of which are hereby incorporated by reference in their entirety as if fully set forth herein . . .

### BACKGROUND OF THE INVENTION

Although a lithium-sulfur battery has a theoretical capacity greater than current commercially available lithium-ion batteries, lithium-sulfur batteries have not yet been commercialized. This is because there are several problems with this type of battery that need to be solved. Current lithium-sulfur batteries have poor cycle stability and conventional ether-based electrolytes have much lower thermal stability than is required for practical use. For example, ether-electrolyte boiling points can be as low as below 50° C., limiting the practical operating temperatures of such batteries at room temperature (<30° C.). Moreover, ether solvents necessitate the use of LiNO₃ additives (to prevent lithium degradation from intermediate products, such as polysulfides), which come with serious transport regulations due to degassing safety concerns. Therefore, despite tremendous research in overcome Li—S battery challenges, the practicality of such battery chemistries is severely hindered.

While carbonate electrolytes are a natural commercialization-friendly choice due to their use in the Li-ion industry for the past three decades, the present state-of-the-art S-cathode chemistries irreversibly react with the carbonate species and shut down the Li—S battery in the first cycle^{8,9}.

Historically, in lithium-sulfur batteries utilizing carbonate electrolytes, only carbon substrates with micropores having less than 1 nm pore diameter have been used to confine sulfur and mitigate the severe chemical decomposition of carbonate species caused by sulfur and prevent battery shutdown. Consequently, this imposes stringent pore size requirements for the host carbon requiring complex synthesis procedures limiting broad deployment, while also theoretically limiting the possible sulfur loading (due to limited available volume of precisely sized micropores).

In the present disclosure, the sulfur content of the porous carbon and the carbonate solvents used in the electrolyte are tailored to address the problem of decomposition of carbonate species. The electrochemical sulfur utilization rate is enhanced concurrently with the provision of long-term cycle stability and protection against heat explosion due to the higher boiling point of the selected carbonate solvents.

Conventional lithium-sulfur batteries are generally composed of a lithium metal anode, a sulfur-containing cathode, and an ether-based electrolyte, such as dimethyl ether (DME) or tetraethylene glycol dimethyl ether (TEGDME). Among other safety-related and low operating temperature-related limiting factors of ether electrolytes, the ether-based electrolytes also participate in increasing the irreversible capacity of the battery (i.e. decreasing cycle stability) by producing liquid-phase intermediates such as long-chained lithium polysulfides (LiPS, Li₂Sₓ, 2<X≤8)¹. Since the sulfur redox reaction mechanism in the ether solvents accompanies multiple phase changes during a cycle, multiple potential plateaus (generally two potential plateaus) are observed during a discharge step. The produced LiPS shuttles between cell components, causing an increase of the ohmic resistance, lithium metal corrosion, and deterioration of the cathode structure. Thus, controlling LiPS formation and diffusivity by chemical and physical approaches are a key factor in enhancing the long-term cycle performance of these batteries.

Carbonate-based electrolytes such as ethylene carbonate (EC), ethylmethyl carbonate (EMC), dimethyl carbonate (DMC), and diethylene carbonate (DEC), have been widely used in industries using lithium-ion batteries because of their reliable thermal and electrochemical stability². For example, these carbonate electrolytes are usually stable up to 100° C. due to their high boiling points, whereas the ether electrolytes begin to decompose at such temperatures due to their lower boiling points. Also, carbonate electrolytes are suitable for high voltage batteries due to their wide potential window. An important advantage of the use of carbonate electrolytes in lithium-sulfur batteries is that the carbonate electrolytes can effectively increase cycle performance by introducing a quasi-solid sulfur conversion reaction, in which only a single potential plateau is generally observed during a cycle. As the formation of soluble LiPSs is thereby minimized, outstanding long-term cycle stability can be obtained by lithium-sulfur batteries employing carbonate electrolytes³.

Lithium-sulfur batteries may use a conventional cathode. However, the use of carbonate electrolytes in lithium-sulfur batteries involves several critical problems which need to be resolved for commercialization to be practical. First, the parasitic reaction between the carbonate species and sulfur must be minimized. Since carbonate species with a high polarity (such as EC and propylene carbonate (PC)) tend to react with the nucleophilic sulfur atom following the nucleophilic substitution (S_{N}2) reaction, the cell typically shuts down in the first cycle (or within a few cycles) as a result of electrolyte decomposition, and deterioration of the cathode results from accumulation of by-products on the surface of the cathode⁴. Second, the cathode structure has to be optimized to increase the sulfur loading. Sulfur loading is an important feature for determining the commercial-viability of lithium-sulfur batteries. According to previous research, only sulfur confined in micropores with a relatively narrow pore diameter of under 1 nm is available for the charge/discharge reaction with carbonate electrolytes without the undesirable S_{N}2 reaction⁴. This means that use of carbonate electrolytes limits the available pore volume in the carbon-sulfur composites leading to a limited sulfur utilization rate and a low sulfur loading. This fact is confirmed in other publications that show the low average sulfur loading (<1.5 mgs cm⁻²) and the sulfur content of the cathode (<30%)⁵. Thus, a well-designed interface between the electrolyte and the cathode is required to improve lithium-sulfur batteries employing carbonate electrolytes.

EP 1 178 555 relates to lithium-sulfur batteries including a negative electrode, a positive electrode, and an electrolyte. The electrolyte of EP ′555 includes at least two groups selected from a weak polar solvent group, a strong polar solvent group and a lithium protection group.

### BRIEF SUMMARY OF THE INVENTION

1. In a first aspect, the present disclosure relates to an electrolyte solvent including:
a) about 0% to about 30% by volume of components i)-iii), based on a total volume of the electrolyte solvent:
   i) one or more unsubstituted cyclic carbonate(s) of Formula (I);
   ii) one or more unsubstituted lactone(s) of Formula (II); and
   iii) one or more unsubstituted oxazolidine(s) of the Formula (III);

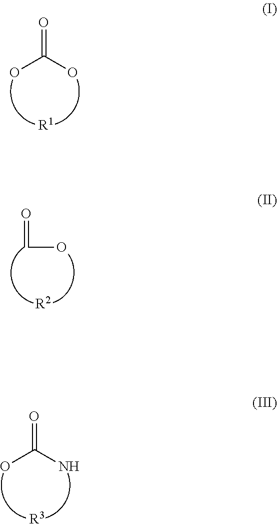

wherein R¹, R², and R³ are each independently selected from a linear hydrocarbylene group having 2 to 10 carbon atoms, or from about 2 to 6 carbon atoms;
b) about 70% to about 100% by volume of components iv)-vii), based on the total volume of the electrolyte solvent:
   iv) one or more substituted cyclic carbonate(s) having about 3 to about 15 carbon atoms;
   v) one or more substituted lactone(s) having about 3 to about 15 carbon atoms; and
   vi) one or more substituted oxazolidine(s) having about 3 to about 15 carbon atoms; and
   vii) one or more acyclic carbonate(s) having about 2 to about 20 carbon atoms; and
   wherein each of iv), v), and vi) each independently comprises a substituted hydrocarbylene group substituted with 1-2 substituents independently selected from a halogen, a hydroxyl group, a hydroxyalkyl group, an amino group, an amide group,
a sulfur containing group, an alkoxyl group, an alkyl group, and an alkenyl group; and wherein the electrolyte solvent has a dielectric constant of 10 or less, as measured by a Puschner Portable Dielectric Measurement Kit at room temperature.

2. The electrolyte solvent of sentence 1, wherein the one or more substituted cyclic carbonate(s) may have Formula (IV), the one or more substituted lactone(s) may have Formula (V), the one or more substituted oxazolidine(s) may have Formula (VI), and the one or more acyclic carbonate(s) may have Formula (VII):

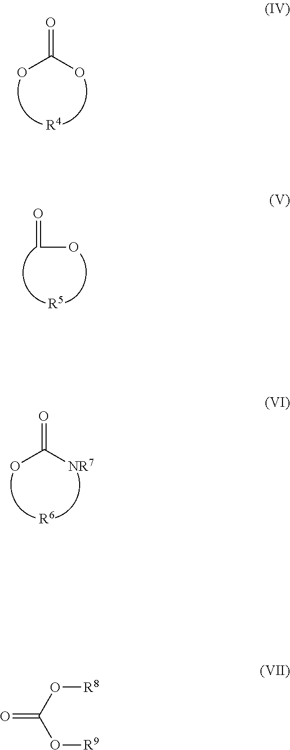

wherein R⁷ is a hydrogen, or an alkyl group having from 1 to 10 carbon atoms, or from 1 to 3 carbon atoms,
R⁸ and R⁹ are each independently selected from an alkyl group having 1 to 10 carbon atoms, or from 1 to 2 carbon atoms, or an alkenyl group having 2 to 10 carbon atoms; and
R⁴, R⁵, and R⁶ are each independently a substituted hydrocarbylene having Formula (VIII):

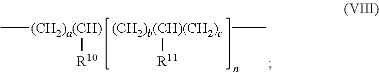

wherein a and c are each independently selected from an integer from 0 to 10, or from 1 to 6, and 10≥a+c≥1;
b is selected from an integer from 0 to 6 or from 0 and 3;
n is selected from 0 and 1;
R¹⁰ and R¹¹ are each independently selected from —NR¹²R¹³, —R¹⁴NR¹⁵R¹⁶, —F, —R¹⁷OR¹⁸, —OR¹⁹, —SR²⁰, —R²¹S, —S⁻², and —R²²;
R¹², R¹³, R¹⁵, R¹⁶, R¹⁸, R¹⁹, and R²⁰ are each independently selected from hydrogen, an alkyl group having 1 to 10 carbon atoms, or an alkenyl group having 2 to 10 carbon atoms,
R¹⁴, R¹⁷, and R²¹ are each independently selected from a hydrocarbylene group having 1 to 10 carbon atoms, and
R²² is selected from an alkyl group having 1 to 10 carbon atoms, or an alkenyl group having 2 to 10 carbon atoms.

3. The electrolyte solvent of any one of sentences 1-2, wherein component a) may be present in an amount of from about 1%-30% by volume, and component b) may be present in an amount of from about 70%-99% by volume, both based on the total volume of the electrolyte solvent.

4. The electrolyte solvent of any one of sentences 2-3, wherein component a) may comprise one or more of the cyclic carbonates according to the Formula (I).

5. The electrolyte solvent of any one of sentences 1-4, wherein component a) may comprise one or more of the cyclic carbonates selected from the group consisting of ethylene carbonate, trimethylene carbonate, tetramethylene carbonate, pentamethylene carbonate, and hexamethylene carbonate.

6. The electrolyte solvent of any one of sentences 2-5, wherein component a) may comprise one or more of the lactones according to the Formula (II).

7. The electrolyte solvent of any one of sentences 1-6, wherein component a) may comprise one or more of the lactones selected from the group consisting of propiolactone, butyrolactone, delta-valerolactone, 6-hexanolactone, and heptanolactone.

8. The electrolyte solvent of any one of sentences 2-7, wherein component a) may comprise one or more of the oxazolidines according to the Formula (III).

9. The electrolyte solvent of any one of sentences 1-8, wherein component a) may comprise one or more of the oxazolidines selected from the group consisting of 1,3-oxazetidine-2-one, 2-oxzolidinone, 1,3-oxazinan-2-one, hexahydro-1,3-oxazepine-2-one, and 1,3-oxazocan-2-one.

10. The electrolyte solvent of any one of sentences 1-9, wherein component b) may comprise any one of the components iv)-vi).

11. The electrolyte solvent of any one of sentences 2-10, wherein component b) may comprise one or more of the substituted cyclic carbonates according to the Formula (IV), optionally selected from propylene carbonate, glycerol carbonate, vinyl ethylene carbonate, fluoroethylene carbonate, 4-(trifluoromethyl)-1,3-dioxolan-2-one, 4-vinyl-1,3-dioxolan-2-one, and vinylene carbonate.

12. The electrolyte solvent of any one of sentences 2-11, wherein component b) may comprise one or more of the substituted lactone(s) according to the Formula (V), optionally selected from delta-valerolactone and gamma-butyrolactone.

13. The electrolyte solvent of any one of sentences 2-12, wherein component b) may comprise one or more of the substituted oxazolidine(s) according to the Formula (VI), optionally comprising 3-methyl-2-oxazolidinone.

14. The electrolyte solvent of any one of sentences 1-13, wherein component b) may comprise one or more of the acyclic carbonates optionally selected from dimethyl carbonate, diethyl carbonate, ethyl methyl carbonate, ethyl acetate, methyl butyrate, ethyl butyrate, methyl (2,2,2-trifluoroethyl) carbonate (FEMC), difluoroethylene carbonate (DFEC), and fluoroethyl carbonate (FEC).

15. The electrolyte solvent of any one of sentences 2-14, wherein n=0 and a=2 to 6.

16. The electrolyte solvent of any one of sentences 2-14, wherein n=1.

17. The electrolyte solvent of sentence 16, may have a dielectric constant of less than 10.

18. The electrolyte solvent of any one of sentences 1-17, wherein component a) may comprise two or more components selected from the components i)-iii).

19. The electrolyte solvent of any one of sentences 1-18, wherein component b) may comprise two or more components selected from the components iv)-vii).

20. In a second aspect, the present disclosure relates to a lithium sulfur battery comprising an anode, a carbon and sulfur containing cathode, and the electrolyte solvent of any one of sentences 1-19.

21. The lithium sulfur battery of claim 20, further comprising one or more lithium salts selected from the group consisting of LiBF₄, LiPF₆, CₙF₂ₙ₊₁CO₂Li, CₙF₂ₙ₊₁SO₃Li, (FSO₂)₂NLi, (CF₃SO₂)₂NLi, (CF₃SO₂)₃NLi, (C₂F₅SO₂)₂NLi, (FSO₂)₂Li, (C₂F₅SO₂)₃NLi, (CF₃SO₂—N—COCF₃) Li, Li(R—SO₂—N—SO₂CF₃) and (C—N)₂CₘF₂ₘ₊₁Li, wherein R is an aliphatic group such as an alkyl or aromatic group and n and m are integers of 1 to 4.

22. A method of preparing a cathode including steps of:
a) mixing a carbon-containing compound with a sulfur-containing compound in a weight ratio of the carbon-containing compound to the sulfur-containing compound of from about 1:2 to 2:1, to form a mixture;
b) heating the mixture from step a) to a temperature of from about 100° C. to about 250° C., for about 1 hour to about 48 hours to form a heated mixture;
c) heating the heated mixture from step b) to a temperature of from about 250° C. to about 550° C., for about 15 minutes to about 10 hours;
d) cooling the mixture of step c) to a temperature of from about 15° C. to 25° C., to form a cathode active material; and
e) mixing the cathode active material with conductive carbon, and one or more polymeric binders to form the cathode.

23. The method of sentence 22, wherein the heating step b) is carried out at a temperature of from about 110° C. to about 200° C., or from about 120° C. to about 190° C.

24. The method of any one of sentences 22-23, wherein the heating step b) is carried out for about 2 hours to about 30 hours, or from about 4 hours to about 24 hours.

25. The method of any one of sentences 22-24, wherein the heating step b) is carried out using a ramping rate of from about 0.25° C./min to about 3.5° C./min.

26. The method of any one of sentences 22-25, wherein the heating step c) is carried out at a temperature of from about 300° C. to about 500° C., or from about 350° C. to about 450° C.

27. The method of any one of sentences 22-26, wherein the heating step c) is carried out for about 30 minutes to about 5 hours, or from about 45 minutes to about 3 hours.

28. The method of any one of sentences 22-27 wherein the heating step c) is carried out using a ramping rate of from about 2° C./min to about 20° C./min, or from about 4° C./min to about 15° C./min, or no faster than 10° C./min.

29. The method of any one of sentences 22-28, wherein the mixing step a) is carried out with the carbon-containing compound and the sulfur-containing compound in a dry state to form a homogeneous mixture.

30. The method of any one of sentences 22-29, wherein the heating steps b) and c) are carried out in an inert atmosphere, and optionally the inert atmosphere consists essentially of argon gas.

31. The method of any one of sentences 22-30, wherein the mixture is cooled in step d) in ambient air.

32. The method of any one of sentences 22-31, wherein the one or more polymeric binders is selected from the group consisting of sodium carboxy methyl cellulose [NaCMC], poly acrylic acid [PAA], polymethacrylic acid, carboxyethyl cellulose, acrylic acid-methacrylic acid copolymer, acrylic acid-alkyl acrylate copolymer acrylic acid-aklylmethacrylate copolymer, methacrylic acid-alkylacrylate copolymer, and methacrylic acid-alkylmethacrylate copolymer.

33. The method of any one of sentences 22-32, wherein the carbon-containing compound is a microporous carbon.

34. The method of sentence 33, wherein the microporous carbon has an average pore diameter of greater than 1 nm, as measured by dynamic light scattering.

35. The method of any one of sentences 33-34, wherein the microporous carbon has a specific surface area of from about 400-1000 m²/g, or from about 500-900 m²/g, as measured by the Brunauer, Emmett, and Teller theory (BET) or has an average pore volume of from about 0.1 cm³/g to about 4 cm³/g, or from about 0.2 cm³/g to about 3.5 cm³/g, as measured by BET.

36. A cathode prepared by the method of any one of sentences 22-35.

37. In a third aspect, the present disclosure relates to a lithium sulfur battery, comprising an anode, the electrolyte solvent of any one of sentences 1-19 and a cathode prepared by the method of any one of sentences 22-35.

The following definition of terms are provided in order to clarify the meaning of certain terms as used herein.

The term “alkyl” as employed herein refers to straight, branched, cyclic, and/or substituted saturated chain moieties of from about 1 to about 10 carbon atoms.

The term “alkenyl” as employed herein refers to straight, branched, cyclic, and/or substituted unsaturated chain moieties of from about 3 to about 10 carbon atoms.

The term “hydrocarbylene substituent” or “hydrocarbylene group” is used in its ordinary sense, which is well-known to those skilled in the art. Specifically, it refers to a group that is directly attached at two locations of the molecule to the remainder of the molecule by a carbon atom and having predominantly hydrocarbon character. Each hydrocarbylene group is independently selected from divalent hydrocarbon substituents, and substituted divalent hydrocarbon substituents containing halo groups, alkyl groups, aryl groups, alkylaryl groups, arylalkyl groups, hydroxyl groups, alkoxy groups, mercapto groups, nitro groups, nitroso groups, amino groups, pyridyl groups, furyl groups, imidazolyl groups, oxygen and nitrogen, and wherein no more than two non-hydrocarbon substituents is present for every ten carbon atoms in the hydrocarbylene group.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIG. 1 shows potential profiles of the microporous carbon (MPC)-sulfur composites with different sulfur contents of from 40 to 80 wt. % at a discharge-charge rate of 0.2 C (1 C=1,672 mA g⁻¹). Specifically, at sulfur loadings of: MPC-S (40 wt. %)=0.87 mgs/cm², MPC-S (50 wt. %)=0.98 mgs/cm², MPC-S (60 wt. %)=2.188 mgs/cm², MPC-S (80 wt. %)=3.05 mgs/cm².

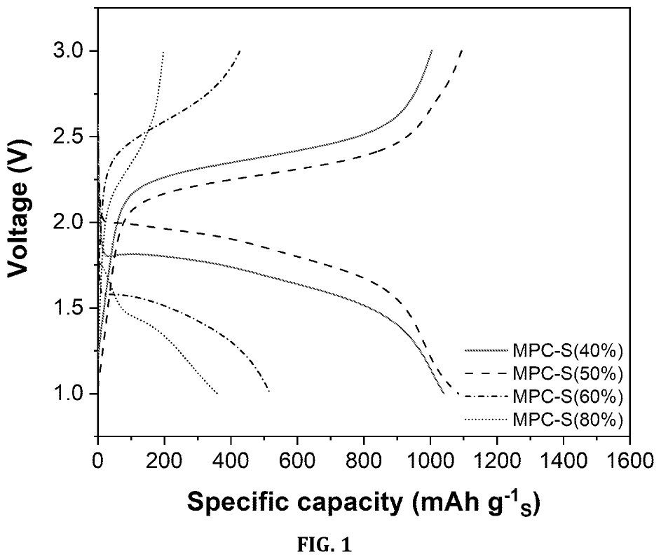

FIG. 2 shows cycling performance of the microporous carbon (MPC)-sulfur composites with different sulfur contents of from 40 wt. % to 80 wt. % at a discharge-charge rate of 0.2 C. Specifically, at sulfur loadings of: MPC-S (40 wt. %)=0.87 mg/cm², MPC-S (50 wt. %)=0.98 mgs/cm², MPC-S (60 wt. %)=2.188 mg/cm², MPC-S (80 wt. %)=3.05 mgs/cm².

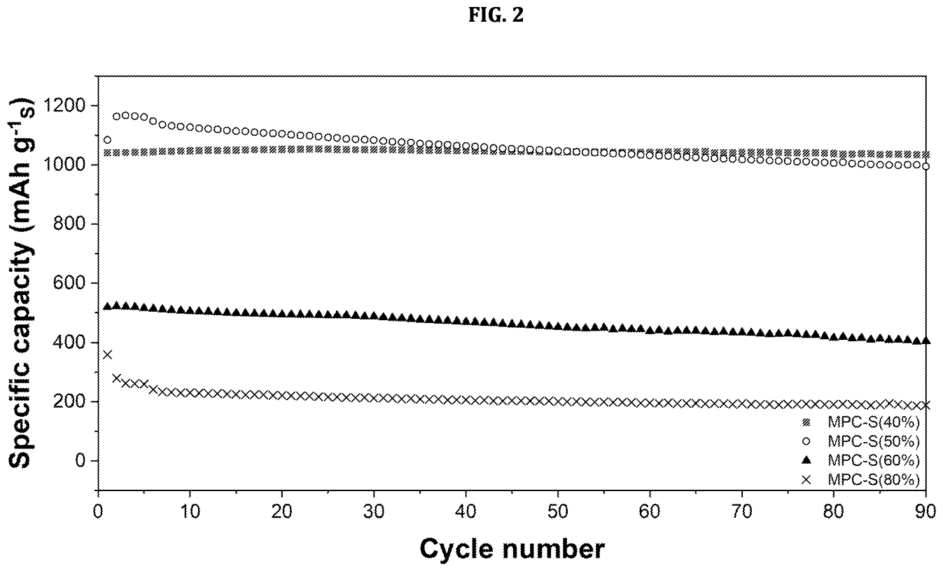

FIG. 3 shows a plot of areal capacity and the specific capacity versus the cycle number of a sulfur and black pearl carbon composite in a 4:6 ratio. Also shown is a prediction of the capacity in the ratios of 5:5, 6:4, and 8:2 of a sulfur and black pearl carbon composite.

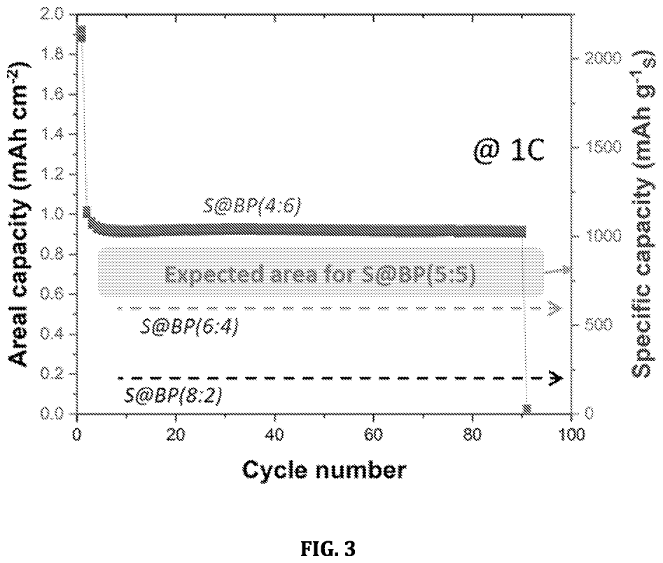

FIG. 4 shows SEM images of a lithium metal roll pressed with polyvinylidene fluoride—hexafluoro propylene (PVDF-HFP) coated carbon fiber gas diffusion layer (GDL) in images (a)-(c). Images (a) and (b) show a top view and image (c) shows a cross-sectional view. Images (d)-(f) show a lithium metal roll pressed with PVDF-HFP coated Si impregnated silicon GDL. Images (d) and (e) show a top view and image (f) is a cross-sectional view.

FIG. 5A shows X-ray photoelectron spectroscopy (XPS) of Li Is spectra of lithium metal protected with PVDF-HFP coated GDL.

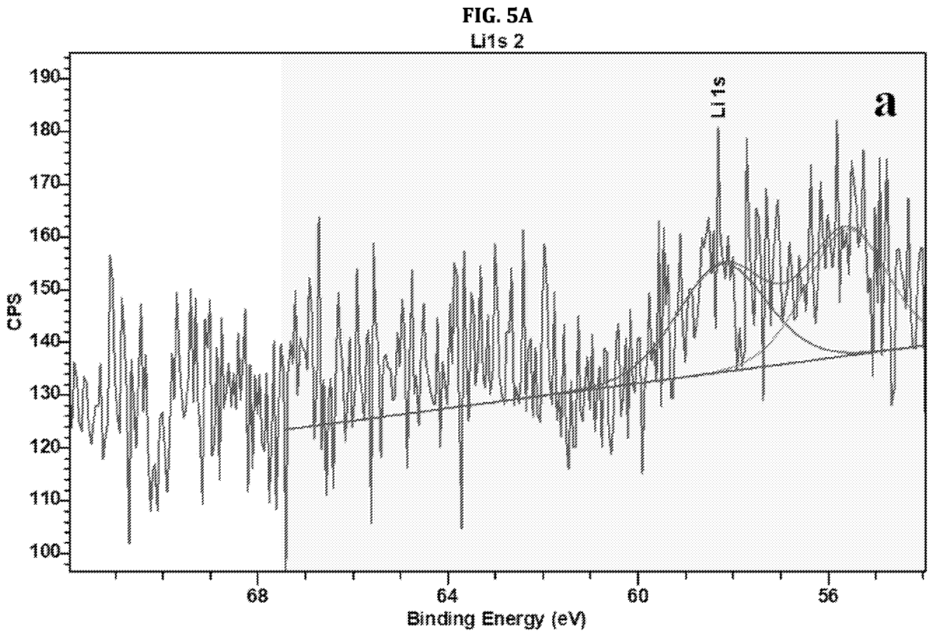

FIG. 5B shows X-ray photoelectron spectroscopy (XPS) of Li Is spectra of lithium metal protected with PVDF-HFP coated GDL-Si.

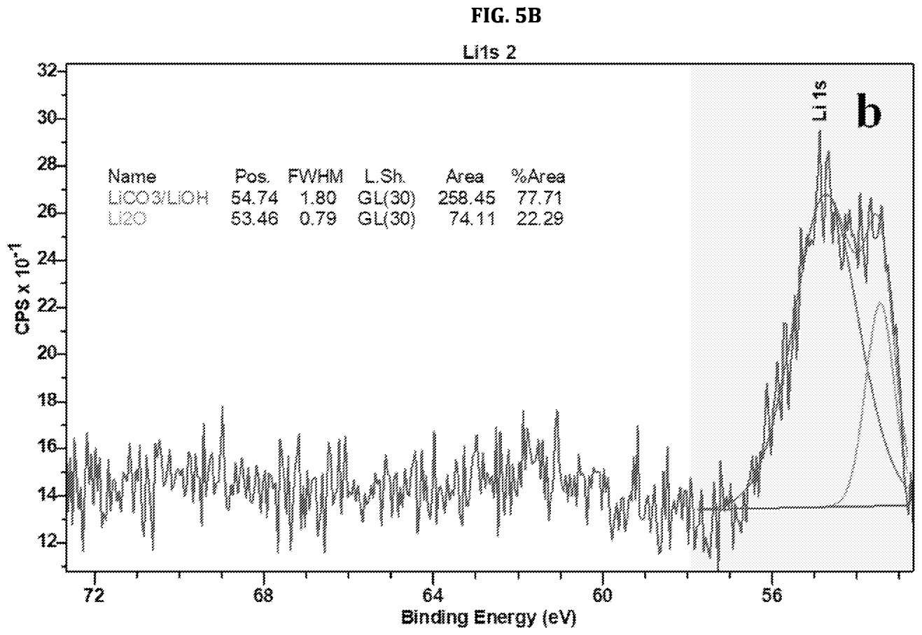

FIG. 5C shows X-ray photoelectron spectroscopy (XPS) of Si 2P spectra of PVDF-HFP coated GDL.

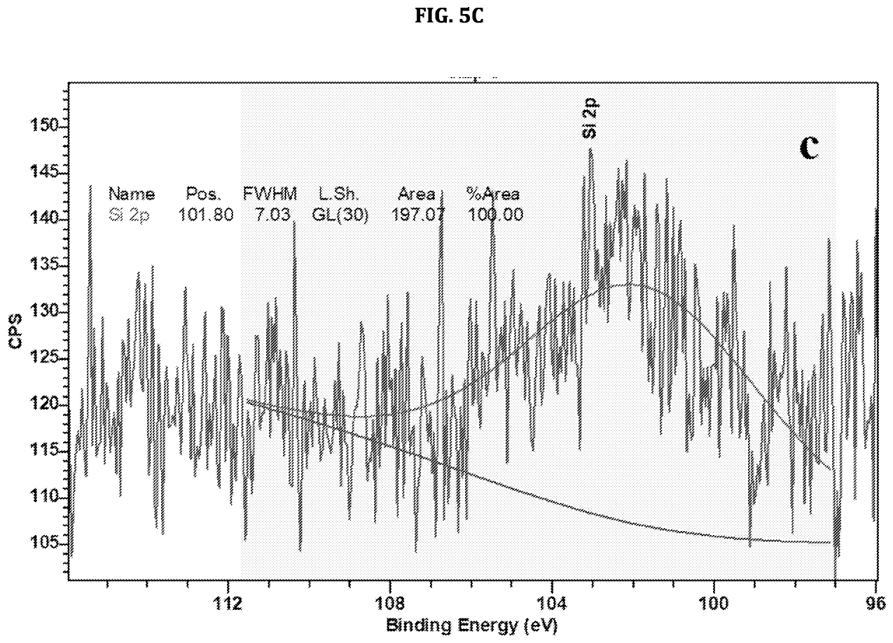

FIG. 5D shows X-ray photoelectron spectroscopy (XPS) of Si 2P spectra of PVDF-HFP coated GDL-Si.

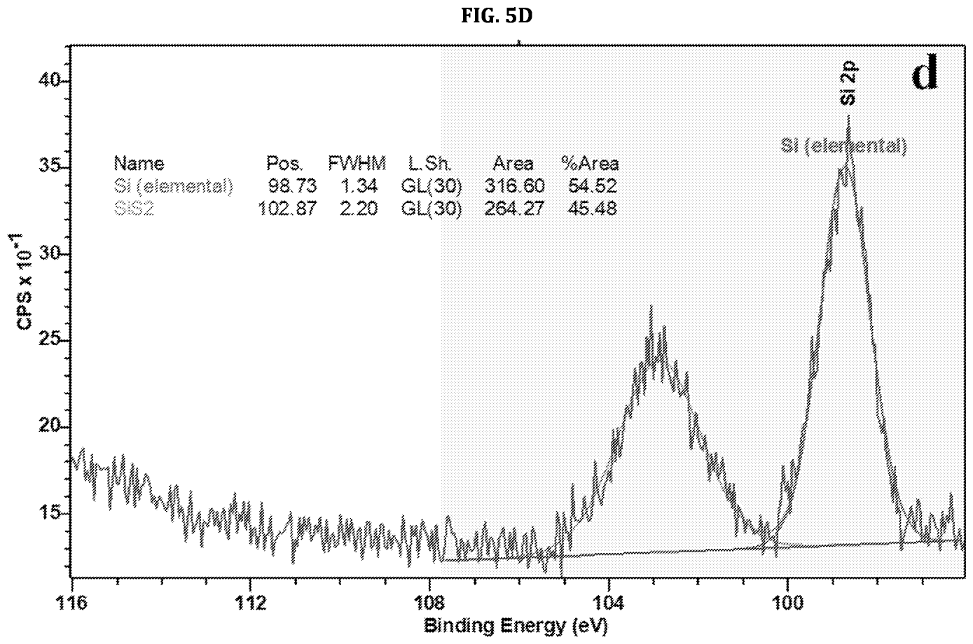

FIG. 6A shows a comparison of the cycle life of a pouch cell comprising lithium metal protected by a combination of GDL fibers-Si as anode and sulfurized polyacrylonitrile (SPAN) as cathode with 5.41 mg/cm² and 6.-5 mg/cm² active material loadings and a GDL fibers anode and SPAN cathode with a 5.18 mg/cm² active material loading in the first cycle. The electrolyte used in the pouch cells was IM LiPF₆ in EC-DEC [1:1 volume ratio] with 5 percent 1,1,2,2 tetrafluoro ethyl, 2,2,3,3 tetrafluoro propyl ether (TTE).

FIG. 6B shows voltage profiles of a pouch cell comprising lithium metal protected by a combination of GDL fibers-Si as anode and SPAN as cathode with 5.41 mg/cm² and 6.05 mg/cm² active material loadings and a GDL fibers anode and SPAN cathode with a 5.18 mg/cm² active material loading in the 4^{th} cycle. The electrolyte used in the pouch cells was 1M LiPF₆ in EC-DEC [1:1 volume ratio] with 5 percent TTE.

FIG. 6C shows voltage profiles of a pouch cell comprising lithium metal protected by a combination of GDL fibers-Si as anode and SPAN as cathode with 5.41 mg/cm² and 6.05 mg/cm² active material loadings and a GDL fibers anode and SPAN cathode with a 5.18 mg/cm² active material loading in the 50^{th} cycle. The electrolyte used in the pouch cells was 1M LiPF₆ in EC-DEC [1:1 volume ratio] with 5 percent TTE.

FIG. 6D shows voltage profiles of a pouch cell comprising lithium metal protected by a combination of GDL fibers-Si as anode and SPAN as cathode with 5.41 mg/cm² and 6.05 mg/cm² active material loadings and a GDL fibers anode and SPAN cathode with a 5.18 mg/cm² active material loading in the 100^{th} cycle. The electrolyte used in the pouch cells was 1M LiPF₆ in EC-DEC [1:1 volume ratio] with 5 percent TTE.

FIG. 7 shows the cycle life of pouch cells with pristine lithium and a SPAN cathode having loadings starting from 2.5 mg/cm². All of the pouch cells were cycled at C/5 and showed poor electrochemical performance in terms of capacity retention and cycle life. Rapid capacity fade is due to the lack of a stable lithium interface which permits dead lithium to form in the solid electrolyte interface (SEI) in each cycle and results in consumption of the electrolyte leading to electrolyte runaway.

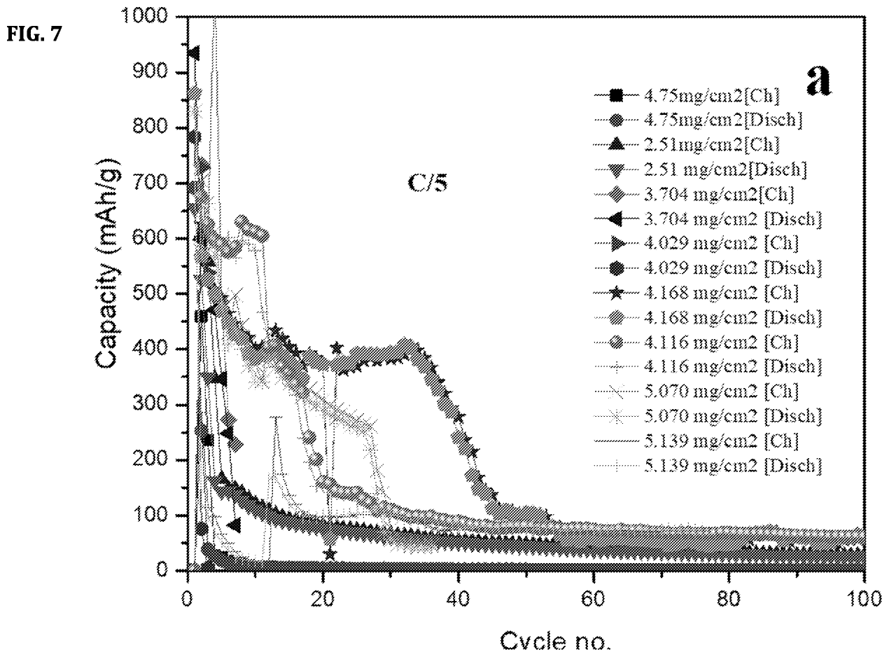

FIG. 8A shows a comparison of an electrochemical impedance spectroscopy (EIS) spectra of coin cells comprising lithium protected with GDL-PVDF and GDL-Si-PVDF as anode and SPAN as cathode at open circuit voltage.

FIG. 8B shows a comparison of an EIS spectra of coin cells comprising lithium protected with GDL-PVDF and GDL-Si-PVDF as anode and SPAN as cathode after 20 cycles.

FIG. 8C shows a comparison of an EIS spectra of coin cells comprising lithium protected with GDL-PVDF and GDL-Si-PVDF as anode and SPAN as cathode after 40 cycles.

FIG. 8D shows a comparison of an EIS spectra of coin cells comprising lithium protected with GDL-PVDF and GDL-Si-PVDF as anode and SPAN as cathode after 70 cycles.

FIG. 8E shows a comparison of an EIS spectra of coin cells comprising lithium protected with GDL-PVDF and GDL-Si-PVDF as anode and SPAN as cathode after 80 cycles.

FIG. 9 shows lithium with a 25.5 cm² area coated by a carbon fiber mat in image (a) and a carbon fiber mat impregnated with lithiophilic material in mage (b), both prepared using roll pressing.

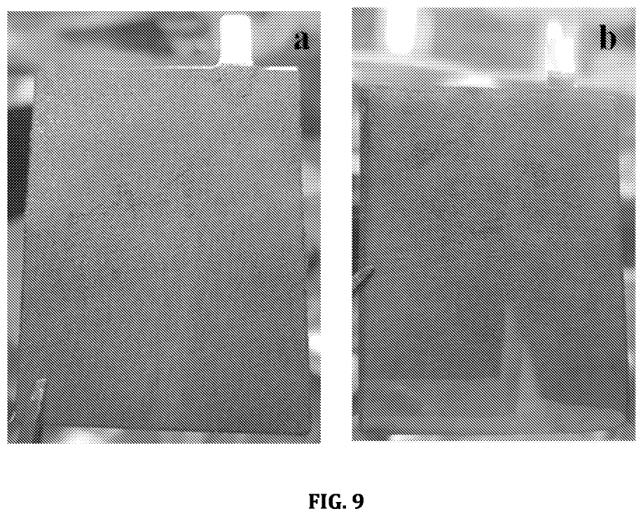

FIG. 10 shows SEM images of lithium metal protected with PVDF-HFP coated GLD in images (a), (b), and (c) and lithium metal protected with PVDF-HFP coated GDL-Si in images (d), (e), and (f).

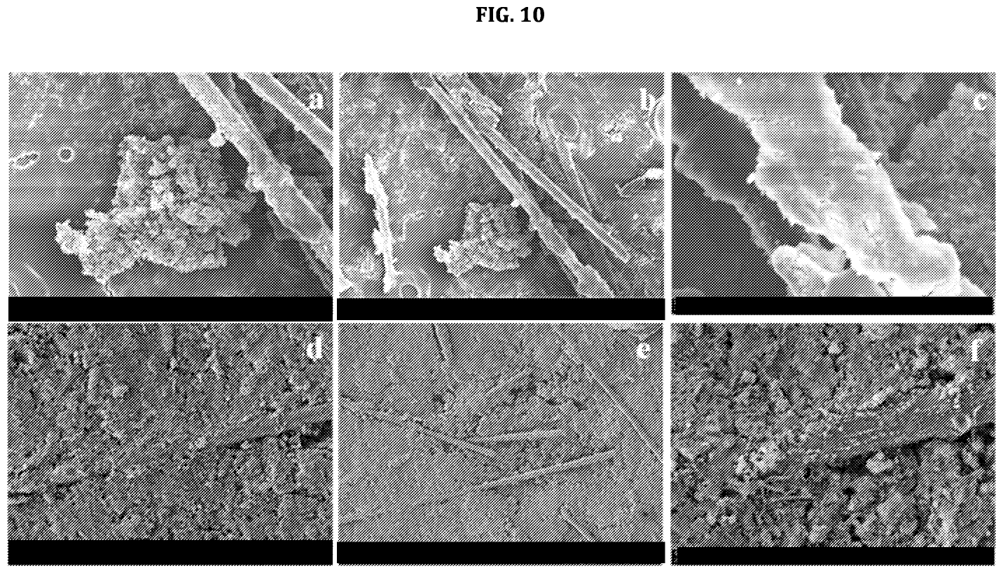

### DETAILED DESCRIPTION OF THE INVENTION

An objective of the disclosure is to increase the sulfur loading of a cathode adapted for use with carbonate electrolytes to provide a high energy density and long cycle life lithium-sulfur battery. In another aspect, the present disclosure relates to controlling, or minimizing the reactivity of carbonates with sulfur or polysulfides to enable successful operation of sulfur batteries in carbonate electrolytes. This objective is achieved by controlling the composition and/or chemistry of the carbonate electrolyte solvent by maintaining an electrolyte solvent composition having a dielectric constant of 10 or less. In an alternative embodiment, the present disclosure relates to a cathode comprising carbon and sulfur infiltrated using a thermal diffusion method.

In one embodiment, the present disclosure relates to an electrolyte solvent including:
a) about 0% to about 30% by volume of components i)-iii), based on a total volume of the electrolyte solvent:
   i) one or more unsubstituted cyclic carbonate(s) of Formula (I);
   ii) one or more unsubstituted lactone(s) of Formula (II); and
   iii) one or more unsubstituted oxazolidine(s) of the Formula (III);

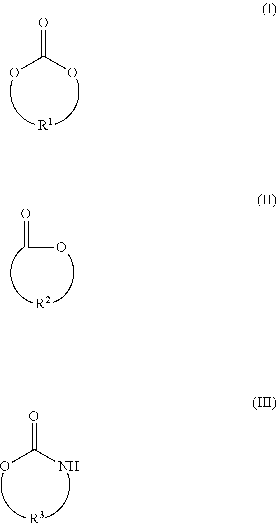

wherein R¹, R², and R³ are each independently selected from a linear hydrocarbylene group having 2 to 10 carbon atoms, or from about 2 to 6 carbon atoms;
b) from about 70% to about 100% by volume of components iv)-vii), based on a total volume of the electrolyte solvent:
   iv) one or more substituted cyclic carbonate(s) having about 3 to about 15 carbon atoms;
   v) one or more substituted lactone(s) having about 3 to about 15 carbon atoms; and
   vi) one or more substituted oxazolidine(s) having about 3 to about 15 carbon atoms; and
   vii) one or more acyclic carbonate(s) having about 2 to about 20 carbon atoms; and
   wherein each of iv), v), and vi) each independently comprises a substituted hydrocarbylene group substituted with 1-2 substituents independently selected from a halogen, a hydroxyl group, a hydroxyalkyl group, an amino group, an amide group, a sulfur containing compound, an alkoxyl group, an alkyl group, and an alkenyl group; and
      wherein the electrolyte solvent has a dielectric constant of 10 or less, as measured by a Puschner Portable Dielectric Measurement Kit at room temperature.

The one or more cyclic carbonate(s) has a formula according to Formula (I), the one or more lactone(s) has a formula according to Formula (II), and the one or more oxazolidine(s) has a formula according to Formula (III):

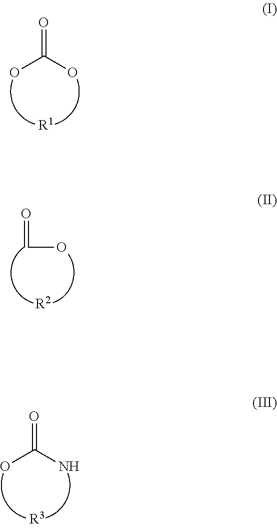

wherein R¹, R², and R³ are each independently selected from a hydrocarbylene having 2 to 10 carbon atoms, or from about 2 to 6 carbon atoms.

The one or more substituted cyclic carbonate(s) may have a formula according to Formula (IV), the one or more substituted lactone(s) may have a formula according to Formula (V), the one or more substituted oxazolidine(s) may have a formula according to Formula (VI), and the one or more acyclic carbonate(s) may have a formula according to Formula (VII):

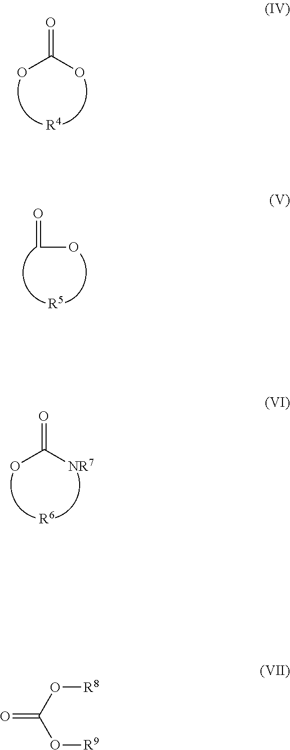

wherein R⁷ is a hydrogen, or an alkyl group having from 1 to 10 carbon atoms, or from 1 to 3 carbon atoms,
R⁸ and R⁹ are each independently selected from an alkyl group having 1 to 10 carbon atoms, or from 1 to 2 carbon atoms, or an alkenyl group having 2 to 10 carbon atoms; and
R⁴, R⁵, and R⁶ are each independently a substituted hydrocarbylene having the Formula (VIII):

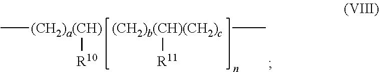

wherein a and c are each independently selected from an integer from 0 to 10, or from 1 to 6, and a+c≥1 and no greater than 10; b is selected from an integer from 0 to 6 or from 0 and 3; n is selected from 0 and 1;
R¹⁰ and R¹¹ are each independently selected from —NR¹²R¹³, —R¹⁴NR¹⁵R¹⁶, —F, —R¹⁷OR¹⁸, —OR¹⁹, —SR²⁰, —R²¹S, —S⁻², and —R²²
R¹², R¹³, R¹⁵, R¹⁶, R¹⁸, R¹⁹, and R²⁰ are each independently selected from hydrogen, an alkyl group having 1 to 10 carbon atoms, or an alkenyl group having 2 to 10 carbon atoms,
R¹⁴, R¹⁷, and R²¹ are each independently selected from a hydrocarbylene group having 1 to 10 carbon atoms, and
R²² is selected from an alkyl group having 1 to 10 carbon atoms, or an alkenyl group having 2 to 10 carbon atoms.

In various embodiments, a cathode with a sulfur loading of at least 40 wt. % is employed in combination with an electrolyte solvent with a total dielectric constant of 10 or less. The electrolytes may be a mixture of one or more of unsubstituted or substituted cyclic carbonates, unsubstituted or substituted lactones, unsubstituted or substituted oxazolidines or acyclic carbonates, such that the overall electrophilicity of the mixture is such that the total dielectric constant of the mixture is 10 or less. The indirect measurement of electrophilicity/nucleophilicity is the dielectric constant. The dielectric constant of a solvent may be defined as the measurement of its polarity. Preferably, the carbonate electrolyte solvent has a dielectric constant of 10 or lower, as measured by a Puschner Portable Dielectric Measurement Kit at room temperature.

The Portable Dielectric Measurement Kit may be used to measure the dielectric constant of solvents and electrolytes. The instrument has an open-ended coaxial dielectric measurement resonator probe where the microwave signals interact with the material to be tested. When the material is touching the open resonator, electromagnetic fields fringe into the material being tested (DUT) and change due to the dielectric properties of the sample, affecting the signal reflected back to the resonator. From these reflection measurements, the resonant frequency and quality factor are determined and related with the dielectric properties by using an in-house numerical procedure. This measurement is carried out at room temperature.

Typically, cyclic carbonates, lactones, and oxazolidines may have a high dielectric constant, whereas substituted cyclic carbonates, substituted lactones, substituted oxazolidines, and acyclic carbonates may have low dielectric constants (low electrophilicity). Thus, one method of achieving a mixture with a low dielectric constant is mixing one or more cyclic carbonates, lactones, and oxazolidines with one or more substituted cyclic carbonates, lactones, oxazolidines, and acyclic carbonates to reduce the overall dielectric constant and indirectly, the electrophilicity of the mixture.

More specifically, the electrophilicity may be reduced by substituting or adding electron releasing groups to the electrophilic part of the cyclic carbonate which indirectly reduces the dielectric constant. The electron releasing groups may be substituted onto the electrophilic part of the cyclic carbonate. Suitable examples of an electron releasing group may be selected from:

NR¹²R¹³, —R¹⁴NR¹⁵R¹⁶, —F, —R¹⁷OR¹⁸, —OR¹⁹, —SR²⁰, —R²¹S, —S⁻², and —R²², wherein R¹², R¹³, R¹⁵, R¹⁶, R¹⁸, R¹⁹, and R²⁰ are each independently selected from hydrogen, an alkyl group having 1 to 10 carbon atoms, or an alkenyl group having 2 to 10 carbon atoms,
R¹⁴, R¹⁷, and R²¹ are each independently selected from a hydrocarbylene group having 1 to 10 carbon atoms, and
R²² is selected from an alkyl group having 1 to 10 carbon atoms, or an alkenyl group having 2 to 10 carbon atoms.

In some embodiments, the electrolyte solvent may comprise one or more cyclic carbonates according to Formula (I), selected from the group consisting of ethylene carbonate, trimethylene carbonate, tetramethylene carbonate, pentamethylene carbonate, and hexamethylene carbonate.

In some embodiments, the electrolyte solvent may comprise one or more lactones according to Formula (II), selected from the group consisting of propiolactone, butyrolactone, delta-valerolactone, 6-hexanolactone, and heptanolactone.

In some embodiments, the electrolyte solvent may comprise one or more oxazolidines according to Formula (III), selected from the group consisting of 1,3-oxazetidine-2-one, 2-oxzolidinone, 1,3-oxazinan-2-one, hexahydro-1,3-oxazepine-2-one, and 1,3-oxazocan-2-one.

In some embodiments, the electrolyte solvent may comprise one or more substituted cyclic carbonates according to Formula (IV), optionally selected from propylene carbonate, glycerol carbonate, vinyl ethylene carbonate, fluoroethylene carbonate, 4-(trifluoromethyl)-1,3-dioxolan-2-one, 4-vinyl-1,3-dioxolan-2-one, and vinylene carbonate.

In some embodiments, the electrolyte solvent may comprise one or more substituted lactone(s) according to Formula (V), optionally selected from delta-valerolactone and gamma-butyrolactone.

In some embodiments, the electrolyte solvent may comprise one or more substituted oxazolidine(s) according to Formula (VI), optionally 3-methyl-2-oxazolidinone.

In some embodiments, the electrolyte solvent may comprise one or more acyclic carbonates, optionally selected from dimethyl carbonate, diethyl carbonate, ethyl methyl carbonate, ethyl acetate, methyl butyrate, ethyl butyrate, methyl (2,2,2-trifluoroethyl) carbonate (FEMC), difluoroethylene carbonate (DFEC), and fluoroethyl carbonate (FEC).

Cyclic carbonates are preferred for use in conventional lithium ion batteries due to their ability to dissociate the lithium salts. Examples of well-known electrolyte solvents for lithium ion batteries contains EC/DEC in a 1:1 volume ratio or EC/EMC/DEC in a 1:1:1 volume ratio. The higher dielectric constant of the cyclic carbonate species originates from the molecular structure, in which the surface charge is confined within the cyclic structure, whereas the acyclic carbonate solvents such as DEC, DMC, and EMC dissipate the surface charge to the edges⁶. However, since the cyclic carbonate solvents have a higher polarity than the acyclic carbonates, a parasitic reaction between the cyclic carbonate solvent and sulfur is facilitated, leading to sudden degradation of the performance of the cell.

In some embodiments, the electrolyte carbonate solvent includes a mixture of one or more substituted cyclic carbonates and one or more acyclic carbonates, wherein the substituted cyclic carbonate is substituted with one or more electron releasing groups, such that the carbonate solvent mixture has a dielectric constant value of 10 or lower. In some embodiments, the carbonate solvent includes a mixture of one or more substituted cyclic carbonates and one or more acyclic carbonates, wherein each substituted cyclic carbonate may be substituted with two or more electron releasing substituent, such that the electrophilicity is reduced and the dielectric constant of the solvent mixture is less than 10.

In the present disclosure, component a) of the electrolyte solvent may be present in an amount of from about 0%-30%, or from about 1%-30%, or from about 5%-25% by volume, and component b) is present in an amount of from about 70%-100%, or from about 70%-99%, or from about 75%-95% by volume, both based on the total volume of the electrolyte.

The key to decreasing carbonate solvent decomposition caused by the S_{N}2 reaction is to minimize the reactivity of, or prevent direct interaction between, the undissolved carbonates and sulfur because the free cyclic carbonate solvents have a higher reactivity than the acyclic carbonate solvents. The use of carbonate solvents with a lower dielectric constant, in combination with a cathode structure containing covalently bonded sulfur decreases this reactivity. Decreasing the concentration of the cyclic carbonate species present at the interfaces with the sulfur atoms can reduce the parasitic reaction. Therefore, electrolytes with a volume ratio of component a) to component b) of less than 3:7 or from 0 to 3:7, will reduce or eliminate such parasitic reactions, to achieve a dielectric constant of 10 or lower.

Suitable examples of unsubstituted and substituted cyclic and acyclic carbonates are illustrated in Table 1 below.

TABLE 1
Organic cyclic and acyclic carbonates as electrolyte solvents⁷

| | | | | | | | Dipole | | d/gcm⁻³, |
|---|---|---|---|---|---|---|---|---|---|
| Solvent | Structure | M. Wt | Tₘ/º C. | T_{b}/° C. | η/cP 25° C. | E 25° C. | Moment/debye | T_{f}/° C. | 25° C. |
| Ethylene carbonate (EC) | 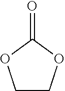 | 88 | 36.4 | 248 | 1.90, (40° C.) | 89.78 | 4.61 | 160 | 1.321 |
| Propylene carbonate (PC) | 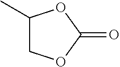 | 102 | −48.8 | 242 | 2.53 | 64.92 | 4.81 | 132 | 1.2 |
| Butylene carbonate (BC) | 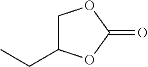 | 116 | −53 | 240 | 3.2 | 53 | | | |
| Gamma- butyrolactone (γBL) | 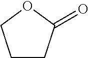 | 86 | −43.5 | 204 | 1.73 | 39 | 4.23 | 97 | 1.199 |
| Gamma- valerolactone (γVL) | 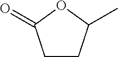 | 100 | −31 | 208 | 2.0 | 34 | 4.29 | 81 | 1.057 |
| 3-methyl-2- oxazolidinone (NMO) | 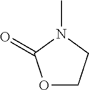 | 101 | 15 | 270 | 2.5 | 78 | 4.52 | 110 | 1.17 |
| Dimethyl carbonate (DMC) | 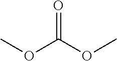 | 90 | 4.6 | 91 | 0.59 (20° C.) | 3.107 | 0.76 | 18 | 1.063 |
| Diethyl carbonate (DEC) | 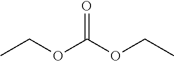 | 118 | −74.3^{a} | 126 | 0.75 | 2.805 | 0.96 | 31 | 0.969 |
| Ethyl methyl carbonate (EMC) | 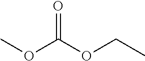 | 104 | −53 | 110 | 0.65 | 2.958 | 0.89 | | 1.006 |
| Ethyl Acetate (EA) | 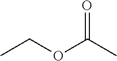 | 88 | −84 | 77 | 0.45 | 6.02 | | −3 | 0.902 |
| Methyl Butyrate (MB) | 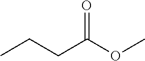 | 102 | −84 | 102 | 0.6 | | | 11 | 0.898 |
| Ethyl butyrate (EB) | 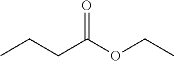 | 116 | −93 | 120 | 0.71 | | | 19 | 0.878 |

The present disclosure also relates to lithium batteries comprising an anode, a carbon and sulfur containing cathode, and an electrolyte solvent composition having a dielectric constant of 10 or less. The electrolyte solvent of the present disclosure allows for a lithium battery to employ a cathode with a higher content of sulfur embedded in wider pores. For example, pores having a diameter of greater than 1 nm can be effectively employed for containing the sulfur. A larger pore diameter allows the sulfur loading in the carbon composition to be increased thereby also increasing the gravimetric energy density.

By controlling the composition and chemistry of carbonate species of the electrolyte solvent by limiting the high dielectric constant solvents, such as the cyclic carbonates, propylene carbonate and ethylene carbonate, the additional sulfur located in the wider pores can participate in the reversible electrochemical reaction without undergoing a significant amount of the undesirable parasitic side-reactions.

The anodes of the present invention may be ion reservoirs, optionally including an active material selected from alkali metals, alkaline earth metals, transition metals, graphite, alloys, and compositions.

Suitable examples of active materials may be selected from lithium, sodium, potassium, magnesium, calcium, zinc, copper, titanium, nickel, cobalt, iron, aluminum, silicon, germanium, tin, lead, antimony, bismuth, manganese, and cadmium, and lithiated versions thereof. The active materials of the anodes may also be alloys or intermetallic selected from compounds of lithium, sodium, potassium, magnesium, calcium, zinc, copper, titanium, nickel, cobalt, iron, aluminum, silicon, germanium, tin, lead, antimony, bismuth, manganese, and cadmium, and lithiated versions thereof, where the alloys or compounds are stoichiometric or non-stoichiometric.

In some embodiments the active materials of the anode may be oxides, carbides, nitrides, sulfides, phosphides, selenides, and tellurides of lithium, sodium, potassium, magnesium, calcium, zinc, copper, titanium, nickel, cobalt, iron, aluminum, silicon, germanium, tin, lead, antimony, bismuth, manganese, and cadmium, and their mixtures or composites, and lithiated versions thereof.

In some embodiments, the active materials of the anodes may be salts of selenides and lithiated versions thereof, or carbon or graphite materials and prelithiated versions thereof; and combinations thereof.

Preferably, the anode in the sulfur batteries may include an active material selected from lithium, sodium, potassium, magnesium, calcium, zinc, copper, titanium, nickel, cobalt, iron, or aluminum. Preferably, the battery is a lithium-sulfur battery, a sodium-sulfur battery, a potassium-sulfur battery, a magnesium-sulfur battery, and a calcium-sulfur battery, and even more preferably, the cell is selected from a lithium-sulfur battery, sodium-sulfur battery, and a potassium-sulfur battery.

Preparation of Composites and a Cathode with High Sulfur Content

This example shows the preparation of a cathode's active material.

### Example 1-Preparation of a Cathode Active Material and Cathode

### Cathode Active Material

A microporous carbon had a specific surface area of 500-900 m² g⁻¹ (as measured by the Brunauer, Emmett, Teller (BET) method, according to ASTM D 3663-78 established on the basis of the BET method, as defined in S. Brunauer P. H. Emmett, E. Teller, J. Am. Chem. Soc., 1938, 60 92), pp 309-319.), a pore volume of 0.2-3.5 cm³ g⁻¹, and an average pore diameter of 0.4-2.0 nm.

Although some reports of using a MPC-S composite as a cathode material indicated that only smaller pores having diameters of less than 1 nm, more preferably 0.5-0.7 nm, were feasible, pore with a larger diameter were found to be effective in the present disclosure when used in combination with an electrolyte solvent with a ratio of high dielectric constant cyclic carbonate solvent to low dielectric constant carbonate solvent of less than 3:7.

### Sulfur Loading

The MPC was mixed with sulfur in an appropriate mass ratio using a mortar/pestle to yield a homogeneous mixture, then sealed in an inert atmosphere, such as argon gas. The sealed container was subjected to a two-step heat treatment, in which the sample was first heated to 120-190° C. using a ramping rate of 0.5-5° C./min over a period of 4-24 hours, then heated to 300-500° C. using a ramping rate of 2-20° C./min per minute for a period of 0.5-5 hours. After cooling under atmospheric conditions to room temperature, the MPC-S composites were obtained. The process of the present disclosure is not limited to a specific form of sulfur because the sulfur melts when heated during the process. As such, even bulk sulfur or any sulfur-containing compound can be used due to the control of the carbonate electrolyte solvent composition/chemistry described above. The sulfur loading can be indirectly measured by measuring the weight loss after a heat treatment at 600-800° C. under an argon atmosphere for 1-5 hours.

### Preparation of the Cathode

A cathode with a high sulfur content was prepared using a slurry coating method. An appropriate ratio of MPC-S composites, conductive carbon (SuperP™), and polymeric binder are mixed in a suitable solvent to dissolve the polymeric binder. The MPC-S comprises more than 60 wt. % of the total powder weight. The well-mixed slurry was spread on an aluminum foil, then coated using a doctor-blade or bar applicator. After drying the coated slurry, the cathode was ready for use.

### Example 2-Preparation of a Cathode Active Material and Cathode

### Preparation of the Cathode Active Material

Appropriate amounts of microporous carbon (BlackPearl2000, Cabot) and elemental sulfur powders were thoroughly mixed in a dried state. The ratio of sulfur to microporous carbon was from 40:60 to 80:20.
The mixed powders were moved to a stainless-steel chamber and sealed tightly under argon in a filled glove box (<0.1 ppm O₂ and H₂O).
The sealed chamber containing the carbon and sulfur mixture was heated by a two-step heat treatment. The initial heat treatment melted the elemental sulfur and diffused the melted sulfur into the micropores of the carbon substrate at about 180° C. over 10 hours using a ramping rate of about 2° C./min. The second heat treatment was carried out to remove superficial sulfur on the carbon substrate at a temperature under 400° C. for 1 hour at a ramping rate of about 5° C./min.
After cooling under atmospheric conditions to room temperature, the resulting microporous-carbon composites were obtained and used as an active material in the cathodes of lithium-sulfur batteries.

### Preparation of the Cathode

A weight ratio of the active material (MPC+S), conductive carbon, and polymeric binder of 8:1:1 was used to fabricate the cathode.
An aqueous binder (polyacrylic acid) was first dissolved in a suitable solvent (deionized water).
The prepared active material containing microporous carbon and sulfur composites and conductive carbon (SuperP™) was thoroughly mixed by a hand-mill process, and this mixture of the active material and the conductive carbon was added to the solvent in which the polymeric binder was dissolved. The solid content was adjusted to about 30%.
The mixture was stirred at 500 to 3000 rpm (1 to 5 times) in a planetary centrifugal mixer.
The mixed slurry was coated on the C-coated Al foil using a doctor-blade. The wet thickness was 50 to 1000 micrometers.
After removing the solvent under vacuum in an oven at 60° C. over 24 hours, the coated slurry on the C-coated Al foil was cut into a circular shape for use as a cathode.

### Example of the Coin Cell Test

All coin cell assembly steps were conducted in an argon-filled glove box (<0.1 ppm of O₂ and H₂O).
1 M LiFSI in an electrolyte mixture of diethyl carbonate (DEC) and fluoroethylene carbonate (FEC) (at a ratio of 70:30, vol. %) was used for all coin cell tests. The electrolyte mixture had a dielectric constant of 10 or less.
Each cell comprised approximately 30 μl of electrolyte.

Materials for Sulfurized polyacrylonitrile (SPAN) synthesis-Polyacrylonitrile (M_{w}=150,000 g mol-1, purchased from Sigma Aldrich) and sulfur (99.5%, sublimed, catalog no. AC201250025), Ethanol (Sigma Aldrich, 99%).

Materials for SPAN electrode making-Carbon black-Super P [Alfa aesar], sodium carboxy methyl cellulose [Alfa aesar], and styrene butadiene rubber (MTI corporation).

Materials for stabilizing the Li-metal-Polyvinylidene fluoride-hexafluoro propylene (Aldrich chemistry), dimethyl formamide (Fisher chemicals), acetone, silicon nanoparticles (100 nm), and GDL fibers (Gas diffusion layer-carbon fiber layer) (3-5 μm diameter).

Materials for electrochemistry-1M lithium hexafluoro phosphate in ethylene carbonate and diethyl carbonate [1:1][LiPF₆ in EC: DEC-Aldrich], fluoro-ethylene carbonate [FEC-Alfa aesar], and 1,1,2,2 tetrafluoro ethyl, 2,2,3,3 tetrafluoro propyl ether (TTE) (TCI).

### SPAN Synthesis

SPAN was synthesized by mixing Polyacrylonitrile (M_{w}=150,000 g mol-1, purchased from Sigma Aldrich) and Sulfur (99.5%, sublimed, catalog no. AC201250025) in 1:4 wt. % and wet ball milled for 12 hours at 400 rpm using ethanol as solvent [Sigma Aldrich, 99%]. The mixture was dried at 50° C. in vacuum oven for 6 hours and finally heat treated in a Tubular furnace [Nabertherm] at 350° C. for 4 hours under nitrogen flow to form SPAN [Sulfurized carbon]. For open synthesis, the polyacrylonitrile (PAN)/S mixture was kept in an open ceramic boat, while for closed synthesis the PAN/S mixture was placed in the alumina ceramic boat closed with the alumina plate followed by wrapping with aluminum foil. For doped SPAN, 2 wt. % of Cobalt chloride (Acros oganics) was added to the PAN/S mixture followed by wet ball milling. The cobalt doped samples were also synthesized in the closed and open system.

Lithium Treatment-Making of 4 wt/Vol % PVDF-HFP-Acetone Solution and Protecting of Li-Metal by PVDF-HFP Coated GDL

400 mg PVDF-HFP was dissolved in 10 ml of the acetone and stirred for 12 hours to make a 4 wt/vol % homogenous solution. The PVDF-HFP solution was drop casted onto the GDL and dried leaving the polymer coating on the GDL fibers. The as obtained PVDF-HFP coated GDL was placed on the Lithium metal surface followed by roll pressing at 0.328 rpm till the desired thickness was achieved. After roll pressing, the lithium was penetrated in between the fibers resulting in pre-lithiation of the fibers and Silicon.

Lithium Treatment-Making of 4 wt/Vol % PVDF-HFP-Acetone Solution and Protecting of Li-Metal by PVDF-HFP Coated GDL-Si

400 mg PVDF-HFP was dissolved in 10 ml of the acetone and stirred for 12 hours to make 4 wt/vol % homogenous solution. For making GDL-Si, 10 wt/vol % of silicon in acetone was made and GDL fibers were immersed in the silicon-acetone solution and rotated at 2000 rpm for 2 minutes during which silicon nano particles were distributed uniformly throughout the GDL fibers. The process of rotation was repeated until a desired weight of silicon was dispersed onto and in between the GDL fibers after which they are dried and drop casted with the PVDF-HFP solution which dried in 2 minutes leaving the polymeric coating onto the GDL fibers which also immobilized the silicon nano particles. The as obtained PVDF-HFP coated GDL-Si was placed on the Lithium metal surface followed by roll pressing at 0.328 rpm till the desired thickness. After roll pressing, the lithium was penetrated in between the fibers resulting in pre-lithiation of the fibers and Silicon.

### Material Characterizations-SEM/EDS, FTIR, XPS, Elemental Analysis, DLS.

The morphological analysis of the materials was conducted using an Scanning electron Microscope (SEM) (Zeiss Supra 50VP, Germany) with an in-lens detector, and a 30-mm aperture was used to examine the morphology and to obtain micrographs of the samples. To analyze the surface elemental composition, Energy Dispersive X-ray Spectroscopy (EDS) (Oxford Instruments) in secondary electron-detection mode was used. The surface of the composites was analyzed with X-ray photoelectron spectroscopy (XPS). To collect the XPS spectra, Al-Ka X-rays, with spot sizes of 200 mm and a pass energy of 23.5 eV were used to irradiate the sample surface. The Al-Ka X-rays use an aluminum element as its source and the X-rays are produced due to the transition of electrons between the core energy levels, i.e. the fall of electrons from the L-shell to the K-shell. A step size of 0.05 eV was used to gather the high-resolution spectra. CasaXPS (version 23.19PR1.0) software was used for spectra analyses. The XPS spectra were calibrated by setting the valence edge to zero, which was calculated by fitting the valence edge with a step-down function and setting the intersection to 0 eV. The background was determined using the Shirley algorithm, which is a built-in function in the CasaXPS software. The infrared spectra of the samples were collected using a Fourier transform infrared (FTIR) spectrometer (Nicolet iS50, Thermo-Fisher Scientific) using an extended range diamond ATR accessory. A deuterated triglycine sulfate (DTGS) with a resolution of 64 scans per spectrum at 8 cm⁻¹ was used and all the spectra were further corrected with background, baseline correction and advanced ATR correction in the Thermo Scientific Omnic software package.

### Electrode Making

Initially 80 wt. % of SPAN and 10 wt. % carbon black super P were mixed in a Flacktek speed mixer for 5 minutes. Homogenous 4 volume percent sodium carboxymethylcellulose-styrene-butadiene rubber (NaCMC-SBR) binder was made in another vial using water as the solvent in the Flacktek speed mixer. Then the SPAN-Carbon black mixture was added to the binder solution in an amount to make up 10 wt. % of the complete electrode slurry and speed mixed for 1 hour at 2500 rpm with 5 minutes gap for each cycle. The resultant electrode slurry was coated onto the carbon coated aluminum foil using an applicator with a thickness of 250 micrometers followed by drying in oven at 50° C.

### Coin-Cell Fabrication

The dried electrodes were cut using a hole punch (f=0.5 inch [12.7 mm]) to form disk-sized electrodes. The electrodes were then weighed and transferred to an argon-filled glove box (MBraun LABstar, O₂<1 ppm and H₂O<1 ppm). The CR2032 (MTI and Xiamen TMAX Battery Equipments, China) coin-type Li—S cells were assembled using SPAN (f=12 mm), lithium disk anodes (Xiamen TMAX Battery Equipment's; f=15.6 mm, 450 mm thick), a tri-layer separator (Celgard 2325; f=19 mm), one stainless-steel spring, and two spacers, along with an electrolyte. The electrolyte with 1M LiPF₆ in EC: December 1:1 volume ratio was purchased from Aldrich chemistry, with H₂O<6 ppm and 02<1 ppm. The assembled coin cells were rested at their open-circuit potential for 12 hours to equilibrate them before performing electrochemical experiments at room temperature. Cyclic voltammetry was performed at various scan rates (0.5 mV/s) between voltages of 1 V and 3 V with respect to Li/Li+ with a potentiostat (Biologic VMP3). Prolonged cyclic stability tests were carried out with a Neware BTS 4000 battery cycler at different C-rates (where 1C=650 mAhg⁻¹) between voltages 1.0 and 3.0 V.

### Pouch Cell Fabrication

Cathodes were punched with dimensions 57 mm×44 mm using a die cutter MSK-T-11 (MTI, USA). A 4-inch (101.6 mm) length lithium strip (750 μm thick, Alfa Aesar) was rolled by placing in between aluminum-laminated film to get a 60 mm×50 mm Li sheet using an electric hot-rolling press (TMAX-JS) at 0.328 rpm inside the glove box (MBraun, LABstar Pro). Once the final dimensions of lithium were achieved (400-500 μm thick-by adjusting the distance between the rollers of the roll press), it was re-rolled with copper current collector (10 mm) to achieve good adhesion. Finally, the lithium-rolled copper sheet was punched with a 58-mm×45-mm die cutter (MST-T-11) inside the glove box. The cathode and anode were welded with aluminum and nickel tabs (3 mm), respectively. The tabs were welded with an 800-W ultrasonic metal welder, with 40 KHz frequency; delay time of 0.2 s, welding time of 0.15 and 0.45 s for AllAl and CulNi, respectively; and cooling time of 0.2 s with 70% amplitude. The anode and cathode were placed between a Celgard 2325 separator, and the pouch was sealed with 3-in-1 heat pouch sealer inside the glove box with a 95 kPa vacuum, 4-s sealing time at 180 C and a 6-s degas time.

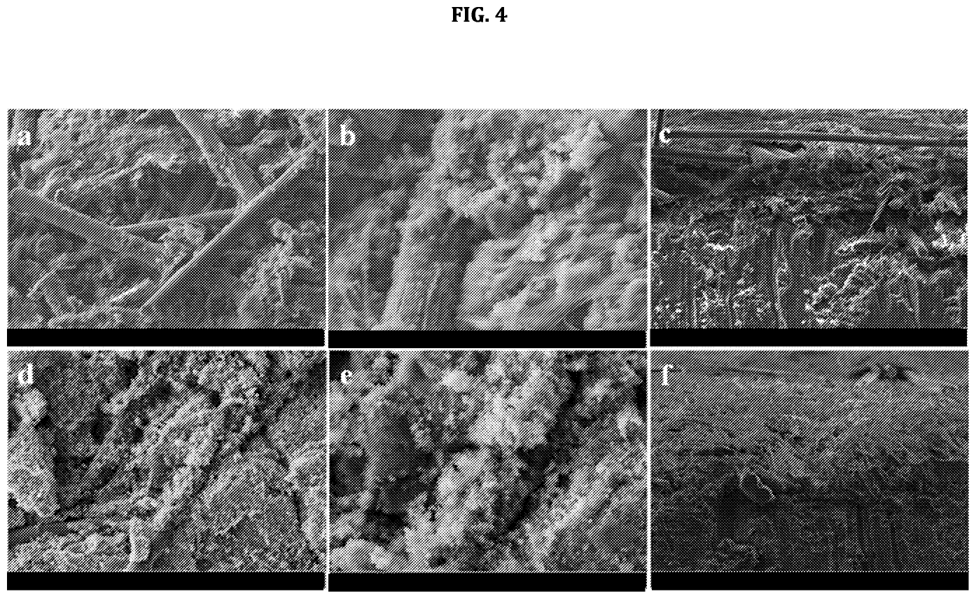

FIG. 4 shows in SEM images (a)-(c) the GDL carbon fibers roll pressed on lithium. These roll pressed GDL carbon fibers are inserted into the bulk of the lithium to act as a skeleton, as evidenced in image (a) of FIG. 4 . . . . The inserted GDL fibers are pre-lithiated, thus creating channels for lithium plating and stripping, see image (b) of FIG. 4. The cross-sectional SEM image (c) of FIG. 4 shows that the thickness of the carbon fiber is about 10-15 μm. Silicon impregnated GDL fibers show complete filling with lithium due to uniform distribution of silicon throughout the GDL fibers. Images (d) and (e) of FIG. 4 show that the fibers are completely coated with the lithium thus creating lithium affinity sites in addition to the pre-lithiated channels. The lithiophilic material improves utilization of the entire GDL fiber mat as evidenced by the fibers no longer being exposed as shown in images (d) and (e) of FIG. 4 when compared to images (a) and (b) of FIG. 4 which show exposed GDL fibers roll pressed onto the lithium with silicon. Image (f) of FIG. 4 is a cross-sectional image of the silicon impregnated GDL roll pressed on the lithium showing a thickness of about 10-15 μm.

XPS was conducted to distinguish the pre-lithiation of GDL with and without silicon combined with etching technology. The Li Is spectra of GDL protected lithium electrode after pre-lithiation of GDL showed a peak at ˜57.2 eV corresponding to Li₂O. A small peak at ˜55 eV corresponds to Li metal. The Li Is spectra of the GDL-Si protected lithium electrode after pre-lithiation showed a prominent peak at ˜54.2 eV corresponding to LiₓSi and another peak at ˜55 eV corresponding to Li-metal. This suggests the formation of Li—Si alloy after roll pressing of the PVDF-HFP coated GDL-Si onto the lithium metal. The silicon 2p spectra of GDL-Li does not show any characteristic peaks of silicon and GDL-Si—Li shows a peak at 98.5 eV corresponding to bulk silicon.

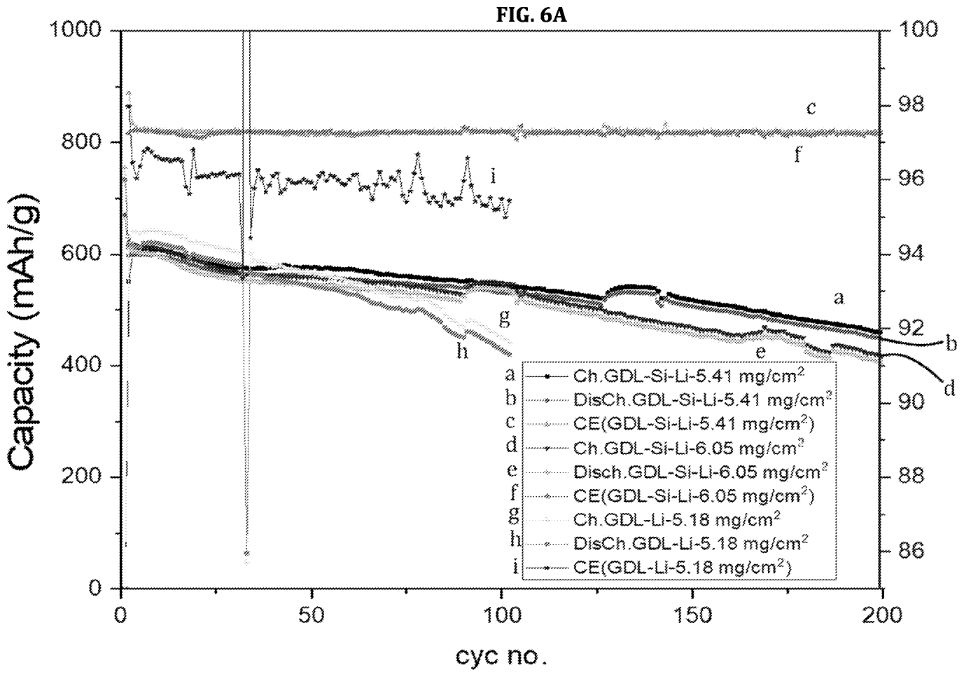

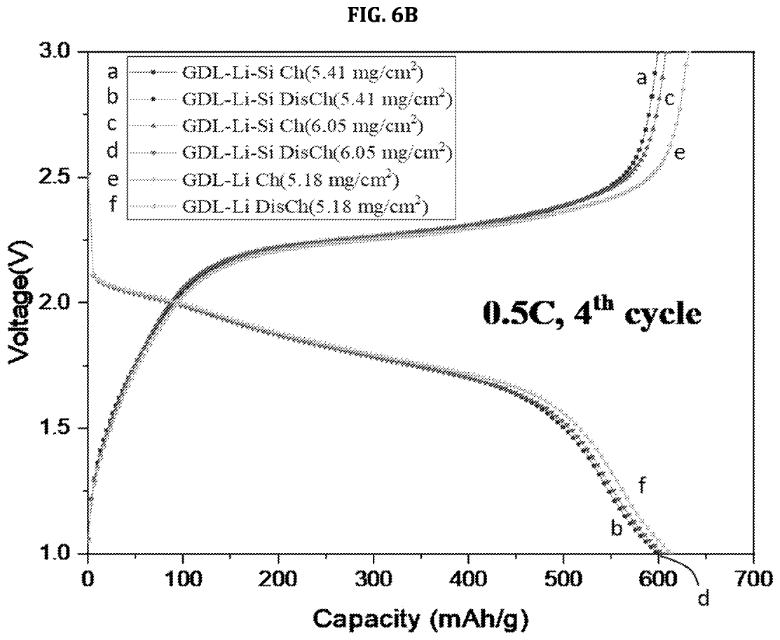

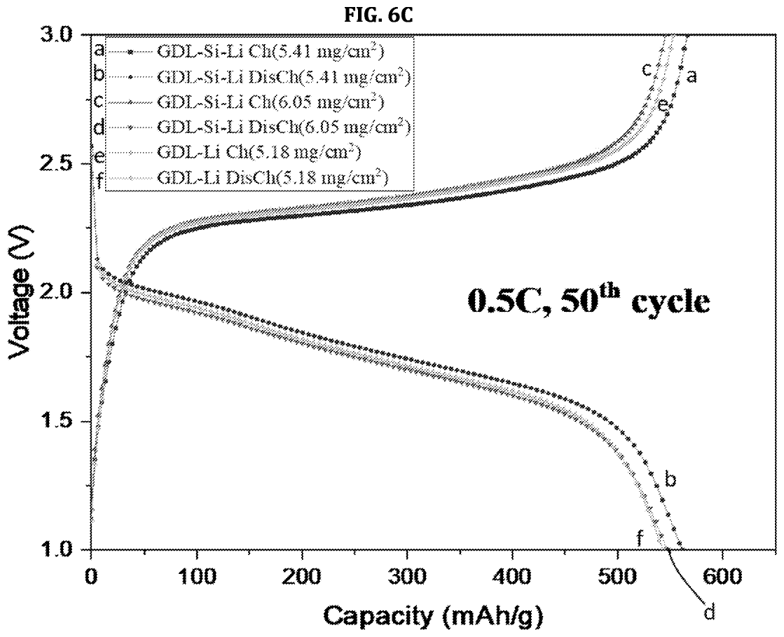

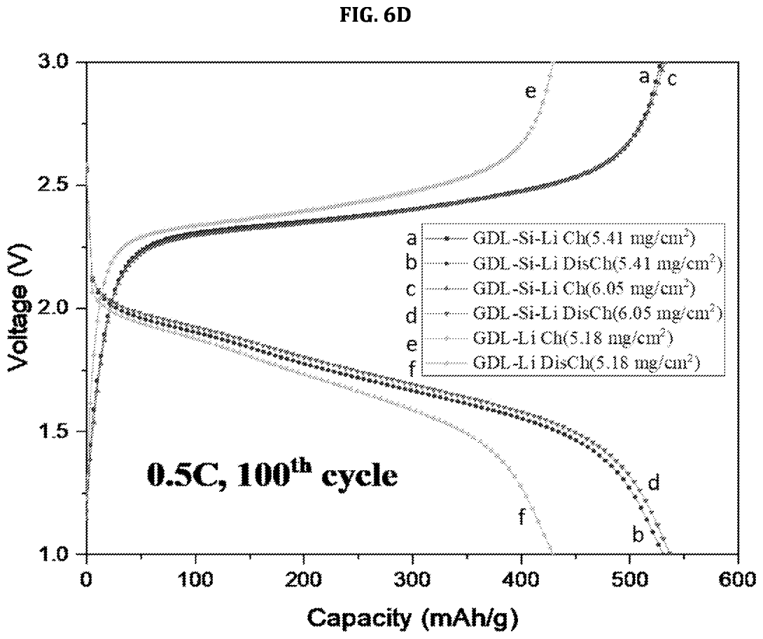

FIG. 6A is a comparison of the cycle life of pouch cells including lithium roll pressed with silicon impregnated with GDL and pristine GDL roll pressed with lithium. The pouch cell with silicon impregnated GDL shows a stable cycle life with good capacity retention with both the 5.41 mg/cm² and the 6.05 mg/cm² SPAN active material loadings, and a coulombic efficiency of nearly 97-98%. In contrast, the pouch cell with the pristine GDL roll pressed with lithium showed an initial high capacity of 630 mAh/g but also exhibited a rapid capacity fade with poor coulombic efficiency.

FIG. 6B shows a comparison of the voltage profiles of the pouch cells in the fourth cycle. The pouch cell with a cathode loading of 5.41 mg/cm² and lithium coated with a carbon fiber GDL mat and lithiophilic material showed a discharge capacity of 605 mAh/g [C/2] at the 4^{th} cycle, 560 mAh/g [C/2] at the 50^{th} cycle and 540 mAh/g at the 100^{th} cycle. The pouch cell with a 6.05 mg/cm² cathode loading having lithium protected with silicon impregnated GDL fibers showed a discharge capacity of 603 mAh/g at the 4^{th} cycle, 550 mAh/g at the 50^{th} cycle and 535 mAh/g at the 100^{th} cycle.

In contrast, the pouch cell having a cathode loading of 5.18 mg/cm² and having the lithium coated with a pristine GDL fiber mat demonstrated a discharge capacity of 600 mAh/g at the 4^{th} cycle, 540 mAh/g at the 50^{th} cycle and 425 mAh/g at the 100^{th} cycle. Accordingly, there is 7.5% loss of capacity in the case of the lithium protected with the GDL fiber mat bearing the lithiophilic material for both cathode loadings, but a 29% loss in capacity is seen in the pouch cell with lithium protected by the GDL fiber mat without the lithiophilic material at the 100^{th} cycle and complete capacity fade is seen after that. Further, there is low polarization and stable cycling with high capacity until 200 cycles in the pouch cell with the lithiophilic material.

These results suggest that there is an improvement in the stability of the roll pressed lithium metal interface coated with the GDL fiber mat and impregnated with lithiophilic material. Furthermore, the pre-lithiation creates a pathway for the Li-ion movement during cycling. This improves the cycle life of the pouch cell. The GDL fiber mat devoid of lithiophilic material cannot support the Li-metal stability at high current densities/high cathode loadings.

The GDL fiber mat with lithiophilic material coated onto the Li-metal showed stable cycle life even with high loadings of 5.41 mg/cm², 6.05 mg/cm². The 3D structure serves as the host and reduces the local current density thereby facilitating uniform lithium flux whereas the silicon improves the lithium affinity thus creating specific lithiophilic sites. As such, there is a combined beneficial effect of the 3D carbon structure and the lithiophilic material for improving the stability of the lithium metal interface and increasing the cycle life even at high loadings thus achieving areal capacities equivalent to 3-4 mAh/cm².

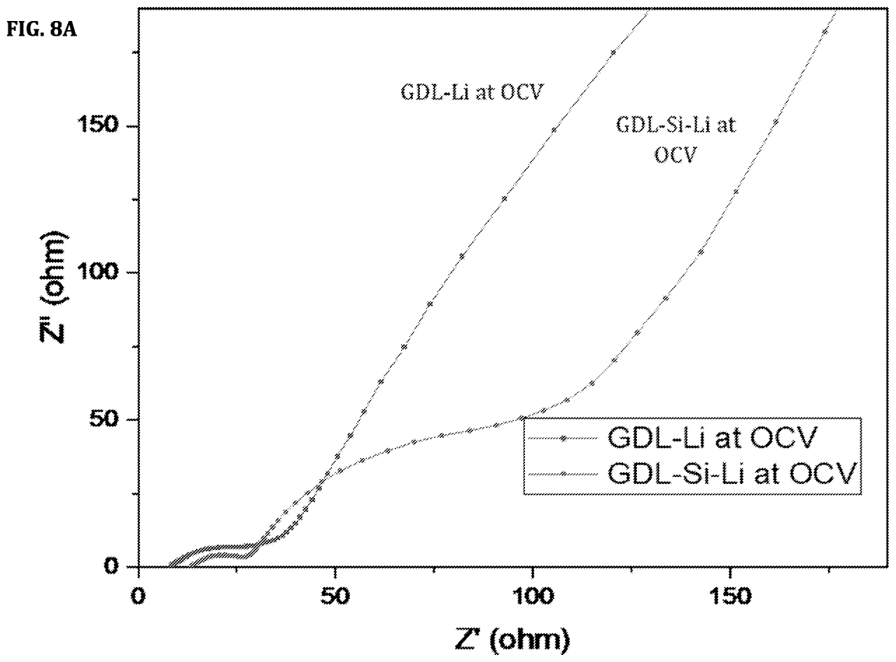

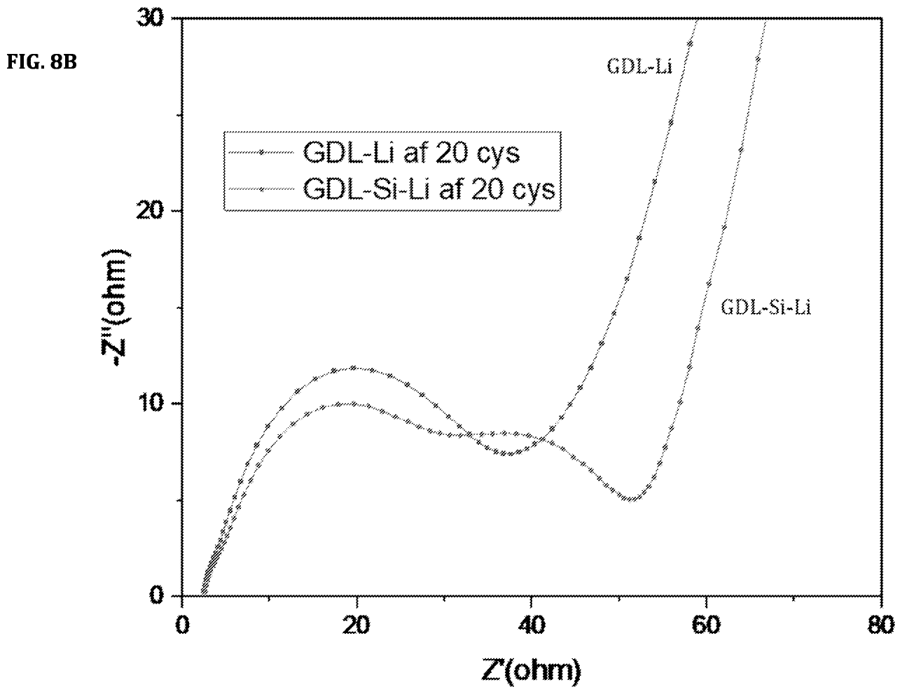

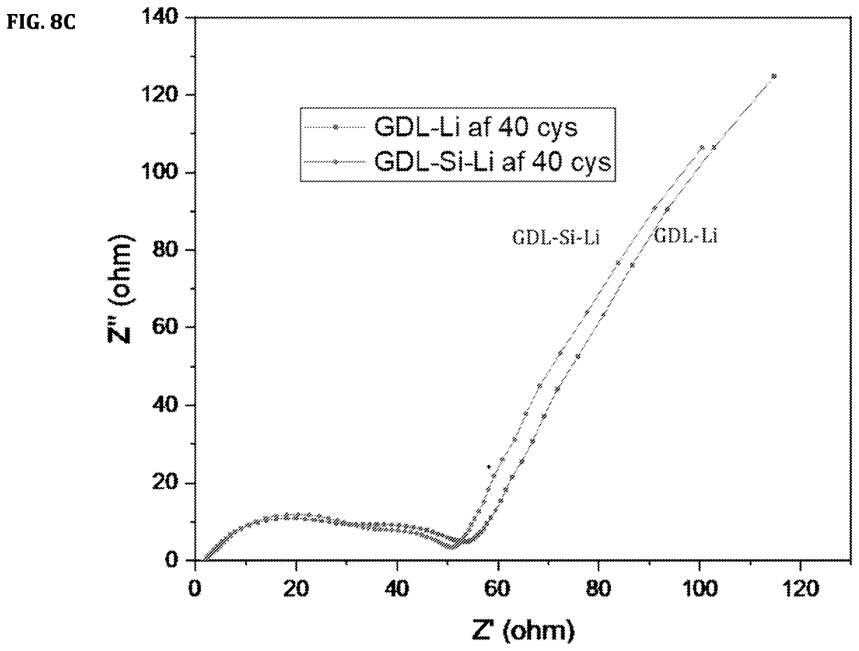

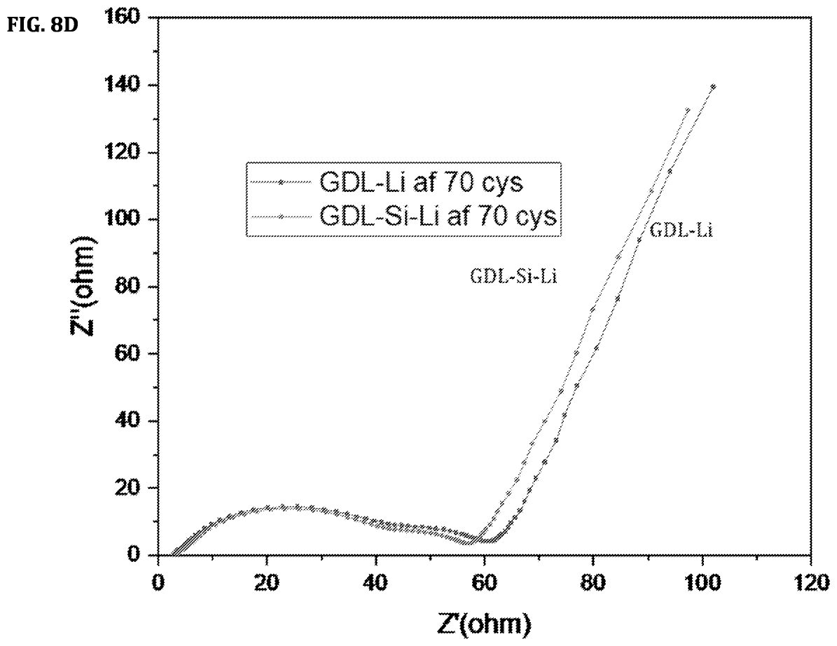

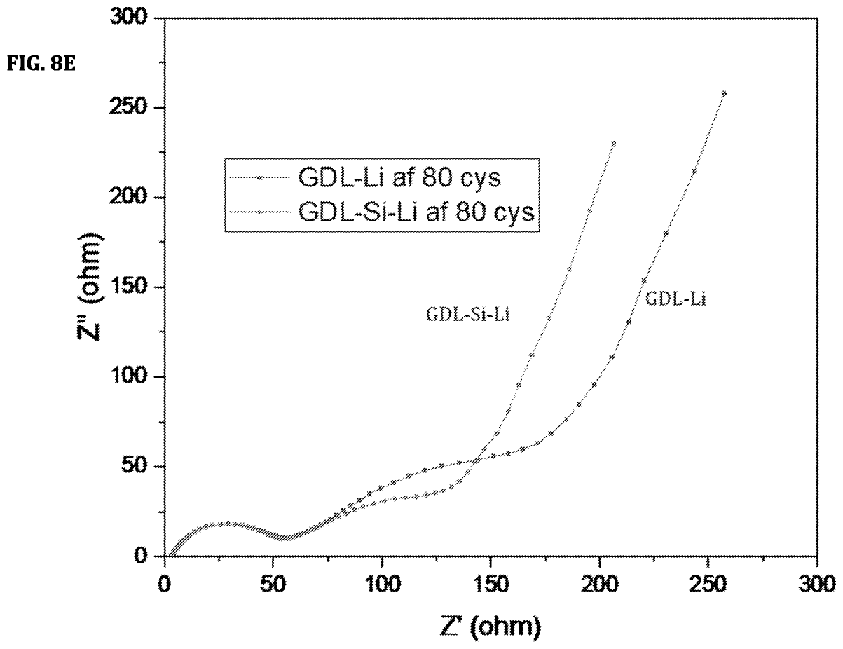

Lithium protected with GDL showed low impedance in terms of charge transfer resistance until 20 cycles compared to lithium protected with GDL-Si. See FIGS. 8A-8E. As the number of cycles progressed there was a gradual increase in the impedance of the lithium protected with GDL. In the EIS after the 80^{th} cycle, the charge transfer resistance of first semi-circle, which was the bulk electrolyte resistance, was nearly the same for both the lithium protected with the GDL and the lithium protected with the GDL-Si, which was approximately 55 ohms. The second semicircle had an electrode resistance that was higher (˜250 ohms) in the case of lithium protected with GDL when compared to the lithium protected with GDL-Si (150 ohm). The higher impedance of Li protected with GDL was due to formation of dendrites and dead lithium. As a result, there was consumption of electrolyte and formation of SEI in every subsequent cycle, which increased the electrode resistance. The lithium protected with GDL-Si had a direct pathway due to the presence of the lithium affinity sites, which maintained the uniformity of the lithium flux, thus minimizing the dendrite and dead lithium formation.

### Postmortem Analysis

To investigate the morphology of the lithium after plating and stripping, the morphology was recorded after 30 cycles. The lithium protected with PVDF-HFP coated GDL showed a bulk agglomerate (30 μm) because of irregular lithium flux during cycling. Although GDL fibers were interconnected, they act as nucleating sites thus forming dead lithium. The morphology of the lithium protected with GDL-Si was uniform with small sized agglomerates distributed throughout the electrode thus maintaining the uniformity. Even the GDL fibers were uniformly coated with the lithium. These observations suggest that the presence of the silicon (lithiophilic material) on the fibers improves the lithium flux thus preventing nucleation and minimizing the formation of dendrites and dead lithium.

Other embodiments of the present disclosure will be apparent to those skilled in the art from consideration of the specification and practice of the embodiments disclosed herein. As used throughout the specification and claims, “a” and/or “an” and/or “the” may refer to one or more than one. Unless otherwise indicated, all numbers expressing quantities, proportions, percentages, or other numerical values are to be understood as being modified in all instances by the term “about.” Accordingly, unless indicated to the contrary, the numerical parameters set forth in the specification and claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1-4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

### REFERENCES

1. Wild, M. et al. Lithium sulfur batteries, a mechanistic review. Energy Environ. Sci. 8, 3477-3494 (2015).
2. Xu, K. Electrolytes and interphases in Li-ion batteries and beyond. Chem. Rev. 114, 11503-11618 (2014).
3. Wang, D. W. et al. A microporous-mesoporous carbon with graphitic structure for a high-rate stable sulfur cathode in carbonate solvent-based Li—S batteries. Phys. Chem. Chem. Phys. 14, 8703-8710 (2012).
4. Yim, T. et al. Effect of chemical reactivity of polysulfide toward carbonate-based electrolyte on the electrochemical performance of Li—S batteries. Electrochim. Acta 107, 454-460 (2013).
5. Li, X. et al. A high-energy sulfur cathode in carbonate electrolyte by eliminating polysulfides via solid-phase lithium-sulfur transformation. Nat. Commun. 9, 1-10 (2018).
6. Xu, K. Nonaqueous Liquid Electrolytes for Lithium-Based Rechargeable Batteries. Chem. Rev. 104, 4303-4418 (2004).
7. Xu, K. Nonaqueous liquid electrolytes for lithium-based rechargeable batteries. Chem. Rev. 104, 4303-4417 (2004).
8. Yim, T.; Park, M.-S.; Yu, J.-S.; Kim, K. J.; Im, K. Y.; Kim, J.-H.; Jeong, G.; Jo, Y. N.; Woo, S.-G.; Kang, K. S. Electrochimica Acta 2013, 107, 454-460.
9. Gao, J.; Lowe, M. A.; Kiya, Y.; Abruna, H. D. The Journal of Physical Chemistry C 2011, 115, (50), 25132-25137.

1. An electrolyte solvent comprising a mixture of:
a) 0% to about 30% by volume of one or more of components selected from the group consisting of components i)-iii), based on a total volume of the electrolyte solvent:
i) one or more unsubstituted cyclic carbonate(s) of Formula (I);
ii) one or more unsubstituted lactone(s) of Formula (II); and
iii) one or more unsubstituted oxazolidine(s) of the Formula (III); 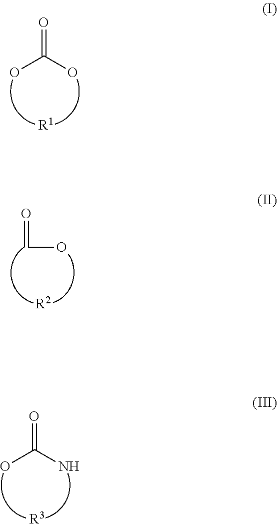
wherein R¹, R², and R³ are each independently selected from the group consisting of a linear hydrocarbylene group having 2 to 10 carbon atoms; and
b) about 70% to 100% by volume of one or more of components selected from the group consisting of components iv)-vii), based on the total volume of the electrolyte solvent:
iv) one or more substituted cyclic carbonate(s) having about 3 to about 15 carbon atoms;
v) one or more substituted lactone(s) having about 3 to about 15 carbon atoms; and
vi) one or more substituted oxazolidine(s) having about 3 to about 15 carbon atoms; and
vii) one or more acyclic carbonate(s) having about 2 to about 20 carbon atoms; and wherein of the components iv), v), and vi) each independently comprises a substituted hydrocarbylene group that is substituted with 1-2 substituents independently selected from the group consisting of a halogen, a hydroxyl group, a hydroxyalkyl group, an amino group, an amide group, a sulfur containing group, an alkoxyl group, an alkyl group, and an alkenyl group; and
the electrolyte solvent has a dielectric constant of 10 or less, as measured by a Puschner Portable Dielectric Measurement Kit at room temperature.

2. The electrolyte solvent as claimed in claim 1, wherein the one or more substituted cyclic carbonate(s) has Formula (IV), the one or more substituted lactone(s) has Formula (V), the one or more substituted oxazolidine(s) has Formula (VI), and the one or more acyclic carbonate(s) has Formula (VII): 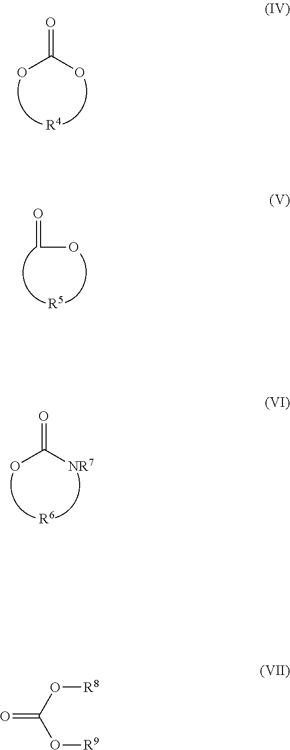
wherein R⁷ is a hydrogen, or an alkyl group having from 1 to 10, carbon atoms,
R⁸ and R⁹ are each independently selected from the group consisting of an alkyl group having 1 to 10 carbon atoms, or an alkenyl group having 2 to 10 carbon atoms; and
R⁴, R⁵, and R⁶ are each independently selected from the group consisting of the substituted hydrocarbylenes having Formula (VIII): 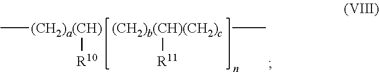
wherein a and c are each independently selected from the group consisting of integers from 0 to 10, and 10≥ a+c≥1;
b is selected from the group consisting of integers from 0 to 6;
n is selected from the group consisting of integers 0 and 1;
R¹⁰ and R¹¹ are each independently selected from the group consisting of NR¹²R¹³, —
R¹⁴NR¹⁵R¹⁶, —F, —R¹⁷OR¹⁸, —OR¹⁹, —SR²⁰, —R²¹S, —S⁻², and —R²²;
R¹², R¹³, R¹⁵, R¹⁶, R¹⁸, R¹⁹, and R²⁰ are each independently selected from the group consisting of hydrogen, an alkyl group having 1 to 10 carbon atoms, and an alkenyl group having 2 to 10 carbon atoms,
R¹⁴, R¹⁷, and R²¹ are each independently selected from the group consisting of a hydrocarbylene group having 1 to 10 carbon atoms; and
R²² is selected from the group consisting of an alkyl group having 1 to 10 carbon atoms, and an alkenyl group having 2 to 10 carbon atoms.

3. The electrolyte solvent of claim 1, wherein the component a) is present in an amount of from about 1%-30% by volume, and the component b) is present in an amount of from about 70%-99% by volume, based on the total volume of the electrolyte solvent.

4. The electrolyte solvent of claim 1, wherein the component a) comprises one or more of the cyclic carbonates according to the Formula (I).

5. The electrolyte solvent of claim 1, wherein the component a) comprises one or more of the cyclic carbonates selected from the group consisting of ethylene carbonate, trimethylene carbonate, tetramethylene carbonate, pentamethylene carbonate, and hexamethylene carbonate.

6. The electrolyte solvent of claim 2, wherein the component a) comprises one or more of the lactones according to the Formula (II).

7. The electrolyte solvent of claim 1, wherein the component a) comprises one or more of the lactones selected from the group consisting of propiolactone, butyrolactone, delta-valerolactone, 6-hexanolactone, and heptanolactone.

8. The electrolyte solvent of claim 2, wherein the component a) comprises one or more of the oxazolidines according to the Formula (III).

9. The electrolyte solvent of claim 1, wherein the component a) comprises one or more of the oxazolidines selected from the group consisting of 1,3-oxazetidine-2-one, 2-oxzolidinone, 1,3-oxazinan-2-one, hexahydro-1,3-oxazepine-2-one, and 1,3-oxazocan-2-one.

10. The electrolyte solvent of claim 1, wherein the component b) comprises any one of the components iv)-vi).

11. The electrolyte solvent of claim 2, wherein the component b) comprises one or more of the substituted cyclic carbonates according to the Formula (IV).

12. The electrolyte solvent of claim 2, wherein the component b) comprises one or more of the substituted lactone(s) according to the Formula (V).

13. The electrolyte solvent of claim 2, wherein the component b) comprises one or more of the substituted oxazolidine(s) according to the Formula (VI).

14. The electrolyte solvent of claim 1, wherein the component b) comprises one or more of the acyclic carbonates.

15. The electrolyte solvent of claim 2, wherein n=0 and a=2 to 6.

16. The electrolyte solvent of claim 2, wherein n=1.

17. The electrolyte solvent of claim 16, wherein the dielectric constant of the electrolyte solvent is less than 10.

18. The electrolyte solvent of claim 1, wherein the component a) comprises two or more components selected from the group consisting of the components i)-iii).

19. The electrolyte solvent of claim 1, wherein the component b) comprises two or more components selected from the group consisting of the components iv)-vii)

20. A lithium sulfur battery comprising an anode, a carbon and sulfur containing cathode, and the electrolyte solvent composition of claim 1.

21. The lithium sulfur battery of claim 20, further comprising one or more lithium salts selected from the group consisting of LiBF₄, LiPF₆, CₙF₂ₙ₊₁ CO₂Li, CₙF₂ₙ₊₁SO₃Li, (FSO₂)₂NLi, (CF₃SO₂)₂NLi, (CF₃SO₂)₃NLi, (C₂F₅SO₂)₂NLi, (FSO₂)₂Li, (C₂F₅SO₂)₃NLi, (CF₃SO₂—N—COCF₃) Li, Li(R—SO₂—N—SO₂CF₃) and (C—N)₂CₘF₂ₘ₊₁Li, wherein R is selected from the group consisting of an aliphatic group and an aromatic group and n and m are integers of 1 to 4.

22. A method of preparing a cathode comprising steps of:
a) mixing a carbon-containing compound with a sulfur-containing compound in a weight ratio of the carbon-containing compound to the sulfur-containing compound of from about 1:2 to 2:1, to form a mixture;
b) heating the mixture from step a) to a temperature of from about 100° C. to about 250° C., for about 1 hour to about 48 hours to form a heated mixture;
c) heating the heated mixture from step b) to a temperature of from about 250° C. to about 550° C., for about 15 minutes to about 10 hours;
d) cooling the mixture of step c) to a temperature of from about 15° C. to 25° C., to form a cathode active material; and
e) mixing the cathode active material with conductive carbon, and one or more polymeric binders to form the cathode.

23-37. (canceled)
